(19) United States
(12) Patent Application Publication
(10) Pub. No.: US 2016/0142937 A1
(43) Pub. Date: May 19, 2016

(54) TECHNIQUES FOR COMPRESSING SESSION INITIATION MESSAGES USING TEMPLATES FOR EVOLVED DATA COMPRESSION SCHEME (EDCS)

(71) Applicant: Qualcomm Incorporated, San Diego, CA (US)

(72) Inventors: Srinivasan Balasubramanian, San Diego, CA (US); Leena Zacharias, San Jose, CA (US); Vishal Dalmiya, San Diego, CA (US); Rohit Kapoor, Bangalore (IN); Shailesh Maheshwari, San Diego, CA (US); Ashwini Raina, Mountain View, CA (US); Seyed Ali Ahmadzadeh, San Jose, CA (US); Ramachandran Subramanian, San Diego, CA (US)

(21) Appl. No.: 14/938,371

(22) Filed: Nov. 11, 2015

Related U.S. Application Data
(60) Provisional application No. 62/080,215, filed on Nov. 14, 2014.

(51) Int. Cl. H04W 28/06; H04L 29/12; H04W 76/04; H04W 76/02; H04L 29/06

(52) U.S. Cl. CPC H04W 28/06; H04W 76/02; H04L 65/1016; H04W 76/046; H04L 61/6063; H04L 61/3085; H04W 80/10

(57) ABSTRACT

Session initiation messages may be compressed using templates for evolved data compression scheme (eDCS). One or more session initiation messages may be exchanged between various network entities, such as UEs and base stations, for purposes such as registration, call setup, and call modification, for example. Session initiation messages may include header fields which identify the caller and characteristics of the device receiving the call, and may also contain payload, which describes the audio/video codec characteristics. Many of these contents may be repeated across all user devices of the same vendor attached to the same operator and may be compressed using templates to enhance system efficiency. These templates may be known at the transmitter and receiver, and reduce the data that has to be carried over air.

### CROSS REFERENCES

The present application for patent claims priority to U.S. Provisional Patent Application No. 62/080,215 by Balasubramanian et al., entitled “Techniques For Compressing Session Initiation Messages Using Templates For Evolved Data Compression Scheme (eDCS),” filed Nov. 14, 2014, assigned to the assignee hereof, which is hereby incorporated by reference in its entirety.

### BACKGROUND

1. Field of the Disclosure

The present disclosure, for example, relates to wireless communications systems, and more particularly to techniques for compressing session initiation messages using templates for evolved data compression scheme (eDCS).

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations, each simultaneously supporting communication for multiple communication devices, otherwise known as user equipments (UEs). A base station may communicate with UEs on downlink (DL) channels (e.g., for transmissions from a base station to a user equipment (UE)) and uplink channels (e.g., for transmissions from a UE to a base station).

When initiating communications in wireless communications systems, various items of information may be exchanged between a UE initiating the communications, one or more base stations, and a UE or other device that may receive or respond to the communications. The items of information may include parameters that identify characteristics of the particular type of communications, identifications of the UE and other devices, which in some cases may be included in one or more headers that are transmitted with the communications. The communications also may include payload data. In many cases, compression schemes may be utilized to compress payload data to enhance efficiency of the wireless communications system. It may also be desirable to employ additional techniques to enhance the efficiency of other items of information, such as header information and various parameters that may be exchanged with a UE when communications are initiated with the UE.

### SUMMARY

The present disclosure may relate generally to wireless communications systems, and more particularly to wireless communications system that may enhance efficiency by compressing session initiation messages using templates for evolved data compression scheme (eDCS). One or more session initiation messages may be exchanged between various network entities, such as UEs and a Proxy-Call Session Control Function (P-CSCF), and may be transmitted via base stations. Session initiation messages may be used for purposes such as registration, call setup, and call modification, for example. Session initiation messages may include header fields, which identify the caller and characteristics of the device receiving the call, and may also contain, in some examples, a payload which describes the audio/video codec characteristics. Many of these contents may be repeated across all user devices of the same vendor attached to the same operator and, according to some examples, may be compressed using templates to enhance system efficiency. These templates may be known at the transmitter and the receiver, and reduce the data that is carried over air.

According to a first set of examples of the disclosure, a method for wireless communications is described, and the method may include identifying a session initiation message that is to be transmitted between a base station and a user equipment (UE); identifying a template associated with the session initiation message; compressing the session initiation message using the identified template; wherein compressing the session initiation message using the identified template may include extracting at least a portion of contents of the identified template from the session initiation message; and transmitting the compressed session initiation message.

In some examples, the template may include one or more parameters repeated across two or more session initiation messages. In some examples, the one or more parameters may include a header field name and header field value. In some examples, identifying the template associated with the session initiation message may include determining a type of session initiation message that is to be transmitted; and selecting the template from a plurality of available compression templates based on the type of session initiation message.

In some examples, the plurality of available compression templates are statically configured. In some examples, the plurality of available compression templates are semi-statically provided by a Proxy-Call Session Control Function (P-CSCF).

In some examples, the P-CSCF determines the plurality of available compression templates based on receiving one or more of a particular message type, and determining contents of the particular message type based on the received one or more of the particular message type. In some examples, the session initiation message may include a plurality of information fields and a payload, and identifying the template associated with the session initiation message may include identifying the template based on one or more of the plurality of information fields or the payload.

In some examples, the compressed session initiation message may include a template ID that indicates the identified template and one or more values associated with the session initiation message. In some examples, the compressing is performed at an IP multimedia subsystem (IMS) stack. In some examples, the compressing of the session initiation message is enabled during an IMS registration procedure.

In some examples, the compressing is performed at a packet data convergence protocol (PDCP) layer. In some examples, the compressing of the session initiation message is enabled using radio resource control (RRC) signaling. In some examples, the compressing is performed using an evolved data compression scheme (eDCS) at the PDCP layer. In some examples, the template is stored in a static eDCS buffer.

In some examples, the method may further include receiving signaling indicating that compressed session initiation messages are to be transmitted; and transmitting an acknowledgment that the compressed session initiation messages are to be transmitted.

In some examples, the signaling may include session initiation signaling that is received at a Proxy-Call Session Control Function (P-CSCF), and the P-CSCF transmits the acknowledgment. In some examples, the signaling may include RRC signaling and the acknowledgment is transmitted using the RRC signaling. In some examples, the compressing is performed using an evolved data compression scheme (eDCS) at a PDCP layer, and the signaling may include RRC signaling indicating that a static eDCS buffer includes the template.

In some examples, the compressing the session initiation message is performed at an IP multimedia subsystem (IMS) stack, and the method may further include generating, at the IMS stack, a compression header for the compressed session initiation message that indicates a template ID of the template; generating a TCP/UDP/IP header for the compressed session initiation message; applying an evolved data compression scheme (eDCS), at a packet data convergence protocol (PDCP) layer, to the TCP/UDP/IP header; and/or transmitting the compression header and the compressed TCP/UDP/IP header with the compressed session initiation message.

In some examples, the compressing is performed at a PDCP layer, and the method may further include generating a TCP/UDP/IP header for the compressed session initiation message; applying an evolved data compression scheme (eDCS) to the TCP/UDP/IP header; providing an indication where the compressed session initiation message starts and a template ID of the template; and transmitting the indication and the compressed TCP/UDP/IP header with the compressed session initiation message.

In some examples, the template is contained in a static buffer of the eDCS.

In some examples, the transmitting may include identifying one or more semi-static fields associated with the compressed session initiation message; further compressing the session initiation message by extracting at least a portion of the one or more semi-static fields from the session initiation message; and transmitting the further compressed session initiation message.

In some examples, the compressing is performed at a packet data convergence protocol (PDCP) layer using an evolved data compression scheme (eDCS) at the PDCP layer, and the template associated with the session initiation message is updated with the one or more semi-static fields.

In some examples, the one or more semi-static fields include one or more of a session initiation uniform resource indicator (URI), an IP address associated with the UE or the base station, or an identification associated with the UE or the base station.

In some examples, the compressing the session initiation message using the identified template is performed at an IP multimedia subsystem (IMS) stack, and wherein the further compressing the session initiation message by extracting at least a portion of the one or more semi-static fields from the session initiation message is performed at a packet data convergence protocol (PDCP) layer.

In some examples, the session initiation message may include a session initiation protocol (SIP) message.

According to the first set of examples, an apparatus for wireless communications is described, and the apparatus may include means for identifying a session initiation message that is to be transmitted between a base station and a user equipment (UE); means for identifying a template associated with the session initiation message; means for compressing the session initiation message using the identified template; wherein compressing the session initiation message using the identified template may include extracting at least a portion of contents of the identified template from the session initiation message; and means for transmitting the compressed session initiation message.

In some examples, the template may include one or more parameters repeated across two or more session initiation messages. In some examples, the one or more parameters may include a header field name and header field value.

In some examples, the means for identifying the template associated with the session initiation message: determines a type of session initiation message that is to be transmitted; and selects the template from a plurality of available compression templates based on the type of session initiation message.

In some examples, the plurality of available compression templates are statically configured. In some examples, the plurality of available compression templates are semi-statically provided by a Proxy-Call Session Control Function (P-CSCF).

In some examples, the P-CSCF determines the plurality of available compression templates based on receiving one or more of a particular message type, and determining contents of the particular message type based on the received one or more of the particular message type.

In some examples, the session initiation message may include a plurality of information fields and a payload, and identifying the template associated with the session initiation message may include identifying the template based on one or more of the plurality of information fields or the payload.

In some examples, the compressed session initiation message may include a template ID that indicates the identified template and one or more values associated with the session initiation message.

In some examples, the compressing is performed at an IP multimedia subsystem (IMS) stack. In some examples, the means for compressing of the session initiation message is enabled during an IMS registration procedure. In some examples, the compression is performed at a packet data convergence protocol (PDCP) layer.

In some examples, the means for compressing of the session initiation message is enabled using radio resource control (RRC) signaling. In some examples, the means for compressing uses an evolved data compression scheme (eDCS) at the PDCP layer. In some examples, the template is stored in a static eDCS buffer.

In some examples, the apparatus may further include means for receiving signaling indicating that compressed session initiation messages are to be transmitted; and means for transmitting an acknowledgment that the compressed session initiation messages are to be transmitted.

In some examples, the signaling may include session initiation signaling that is received at a Proxy-Call Session Control Function (P-CSCF), and the P-CSCF transmits the acknowledgment. In some examples, the signaling may include RRC signaling and the acknowledgment is transmitted using the RRC signaling.

In some examples, the means for compressing uses an evolved data compression scheme (eDCS) at a PDCP layer, and the signaling may include RRC signaling indicating that a static eDCS buffer includes the template.

In some examples, the means for compressing the session initiation message may include an IP multimedia subsystem (IMS) stack. In some examples, the apparatus may further include means for generating, at the IMS stack, a compression header for the compressed session initiation message that indicates a template ID of the template; means for generating a TCP/UDP/IP header for the compressed session initiation message; means for applying an evolved data compression scheme (eDCS), at a packet data convergence protocol (PDCP) layer, to the TCP/UDP/IP header; and means for transmitting the compression header and the compressed TCP/UDP/IP header with the compressed session initiation message.

In some examples, the means for compressing may include a PDCP layer. In some examples, the apparatus may further include means for generating a TCP/UDP/IP header for the compressed session initiation message; means for applying an evolved data compression scheme (eDCS) to the TCP/UDP/IP header; means for providing an indication where the compressed session initiation message starts and a template ID of the template; and means for transmitting the indication and the compressed TCP/UDP/IP header with the compressed session initiation message.

In some examples, the template is contained in a static buffer of the eDCS. In some examples, the means for transmitting: identifies one or more semi-static fields associated with the compressed session initiation message; further compresses the session initiation message by extracting at least a portion of the one or more semi-static fields from the session initiation message; and transmits the further compressed session initiation message.

In some examples, the means for compressing may include a packet data convergence protocol (PDCP) layer using an evolved data compression scheme (eDCS) at the PDCP layer, and the template associated with the session initiation message is updated with the one or more semi-static fields.

In some examples, the one or more semi-static fields include one or more of a session initiation uniform resource indicator (URI), an IP address associated with the UE or the base station, or an identification associated with the UE or the base station. In some examples, the session initiation message may include a session initiation protocol (SIP) message.

According to the first set of examples, another apparatus for wireless communications is described, and the apparatus may include a processor, and a memory in electronic communication with the processor and instructions stored in the memory, the instructions being executable by the processor to identify a session initiation message that is to be transmitted between a base station and a user equipment (UE); identify a template associated with the session initiation message; compress the session initiation message using the identified template; wherein compressing the session initiation message using the identified template may include extracting at least a portion of contents of the identified template from the session initiation message; and transmit the compressed session initiation message.

According to the first set of examples, a non-transitory computer-readable medium storing code for wireless communications is described, and the code may include instructions executable by a processor to identify a session initiation message that is to be transmitted between a base station and a user equipment (UE); identify a template associated with the session initiation message; compress the session initiation message using the identified template; wherein compressing the session initiation message using the identified template may include extracting at least a portion of contents of the identified template from the session initiation message; and transmit the compressed session initiation message.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system, in accordance with various aspects of the disclosure;

FIG. 2 illustrates an example of a communication flow in a wireless communications system, in accordance with various aspects of the present disclosure;

FIG. 3 illustrates an example of a wireless communications system that transmits session initiation messages using compression templates, in accordance with various aspects of the present disclosure;

FIG. 4 illustrates an example of a wireless communications system that transmits session initiation messages using compression templates, in accordance with various aspects of the present disclosure;

FIG. 5A illustrates an example of an eDCS header, in accordance with various aspects of the present disclosure;

FIG. 5B illustrates another example of an eDCS header, in accordance with various aspects of the present disclosure;

FIG. 5C illustrates another example of an eDCS header, in accordance with various aspects of the present disclosure;

FIG. 6 shows a block diagram of a device for use in wireless communications, in accordance with various aspects of the present disclosure;

FIG. 7 shows a block diagram of a device for use in wireless communications, in accordance with various aspects of the present disclosure;

FIG. 8 shows a system for use in wireless communications, in accordance with various aspects of the present disclosure;

FIG. 9 shows a block diagram of an apparatus for use in wireless communications, in accordance with various aspects of the present disclosure;

FIG. 10 shows a block diagram of an apparatus for use in wireless communications, in accordance with various aspects of the present disclosure;

FIG. 11 shows a block diagram of a base station for use in wireless communications, in accordance with various aspects of the present disclosure;

FIG. 12 shows a block diagram of a multiple input/multiple output (MIMO) communication system including a base station and a UE, in accordance with various aspects of the present disclosure;

FIG. 13 is a flow chart illustrating an example of a method for wireless communications, in accordance with various aspects of the present disclosure;

FIG. 14 is a flow chart illustrating an example of a method for wireless communications, in accordance with various aspects of the present disclosure; and

FIG. 15 is a flow chart illustrating an example of a method for wireless communications, in accordance with various aspects of the present disclosure.

### DETAILED DESCRIPTION

The present disclosure may relate generally to wireless communications systems, and more particularly to wireless communications system that may enhance efficiency by compressing session initiation messages using templates for evolved data compression scheme (eDCS). One or more session initiation messages may be exchanged between various network entities, such as UEs and base stations, for purposes such as registration, call setup, and call modification, for example. Session initiation messages may include header fields which identify the caller characteristics of the device receiving the call, and may also contain, in some examples, payload which describes the audio/video codec characteristics. Many of these contents may be repeated across all user devices of the same vendor attached to the same operator and, according to some examples, may be compressed using templates to enhance system efficiency. These templates may be known at the transmitter and receiver, and reduce the data that is carried over air. A wireless communications system which employs such templates for data compression may experience increased system capacity (e.g., by accommodating higher bandwidth and increased number of users), faster data exchange (e.g., quicker web page downloads), improved call setup (e.g., during cell edge scenarios for session initiation protocol (SIP) procedures), and UE transmit power benefits.

For example, a wireless communications system may use IP multimedia subsystem (IMS) traffic, which uses Session Initiation Protocol (SIP) for signaling purposes like registration, call setup, call modification, etc. SIP messages, according to this established protocol, contain header fields which identify the caller and characteristics of the receiver of the call, and may also contain Session Description Protocol (SDP) payload which describes the audio/video codec characteristics. Most of these contents are repeated across all user devices of the same vendor attached to the same operator. In some examples, these repeated contents may be compressed using one or more compression templates. These compression templates may be known at one or more UEs using the wireless communications system, as well as at one or more base stations of the wireless communications system. The compression templates may allow for reduction of the amount of data that would otherwise need to be transmitted using one or more radio frequency channels of the wireless communications system.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

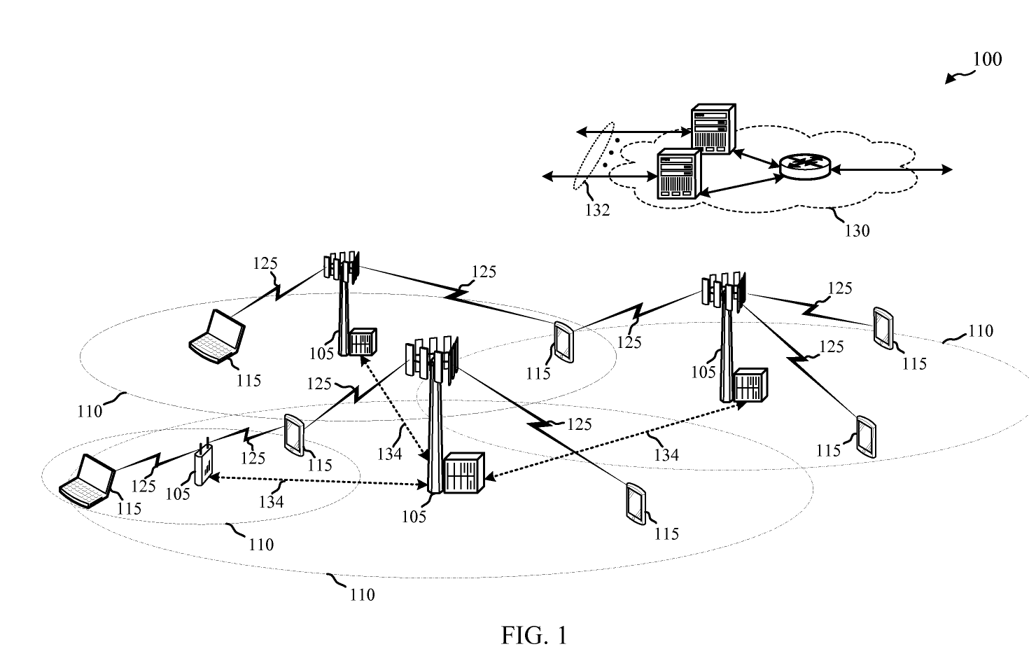

FIG. 1 illustrates an example of a wireless communications system 100, in accordance with various aspects of the disclosure. The wireless communications system 100 includes at least one base station 105, at least one UE 115, and a core network 130. The core network 130 may provide user authentication, access authorization, tracking, Internet Protocol (IP) connectivity, and other access, routing, or mobility functions. The base station 105 interface with the core network 130 through backhaul links 132 (e.g., S1, etc.) and may perform radio configuration and scheduling for communication with the UEs 115, or may operate under the control of a base station controller (not shown). In various examples, at least one base station 105 may communicate, either directly or indirectly (e.g., through core network 130), with each other over backhaul links 134 (e.g., X2, etc.), which may be wired or wireless communications links.

At least one base station 105 may wirelessly communicate with the UEs 115 via one or more base station antennas. Each of the base station 105 sites may provide communication coverage for a respective geographic coverage area 110. In some examples, base station 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include instances of base station 105 of different types (e.g., macro and/or small cell base stations). There may be overlapping geographic coverage areas 110 for different technologies.

In instances where a UE 115 may desire to initiate a new communications session, such as a new voice call, for example, the UE 115 may transmit session initiation messages. These session initiation messages may, in some examples, be compressed using compression templates, in order to reduce the amount of data that is to be transmitted over the air. In some examples, a transmitter, such as a UE 115 or base station 105, may identify a session initiation message that is to be transmitted, and identify a template associated with the session initiation message. The session initiation message may be compressed using the identified template by, for example, extracting at least a portion of contents of the identified template from the session initiation message. The compressed session initiation message may then be transmitted to a receiver, such as a base station 105 or UE 115.

In some examples, the wireless communications system 100 is an LTE/LTE-A network. In LTE/LTE-A networks, the term evolved Node B (eNB) may, for example, be used to describe the base station 105, while the term UE may, for example, be used to describe the UEs 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell, for example, covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARD) to provide retransmission at the MAC layer to improve link efficiency. In the control plane, the Radio Resource Control (RRC) protocol layer may provide establishment, configuration, and maintenance of an RRC connection between a UE 115 and at least one base station 105 or core network 130 supporting radio bearers for the user plane data. At the Physical (PHY) layer, the transport channels may be mapped to Physical channels.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communications device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

The at least one communication link 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication link 125 may transmit bidirectional communications using frequency division duplexing (FDD) (e.g., using paired spectrum resources) or time division duplexing (TDD) operation (e.g., using unpaired spectrum resources). Frame structures for FDD (e.g., frame structure type 1) and TDD (e.g., frame structure type 2) may be defined.

In some examples of the wireless communications system 100, base station 105 and/or UEs 115 may include multiple antennas for employing antenna diversity schemes to improve communication quality and reliability between base station 105 and UEs 115. Additionally or alternatively, base station 105 and/or UEs 115 may employ multiple-input, multiple-output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

According to the present disclosure, a UE 115 or a base station 105 may determine that one or more session initiation messages, such as one or more SIP messages for example, are to be transmitted to initiate a communications session. Following an initial transmission of a session initiation message, one or more additional session initiation messages may be transmitted in order to complete the initiation of the session. One or more of these session initiation messages may be compressed through the use of compression templates that allow for transmission of only data that may change based on, for example, an identity of a UE 115 or a base station 105, and not transmission of information that remains constant for the session initiation message for the operator and UE 115, such as various header field names, for example.

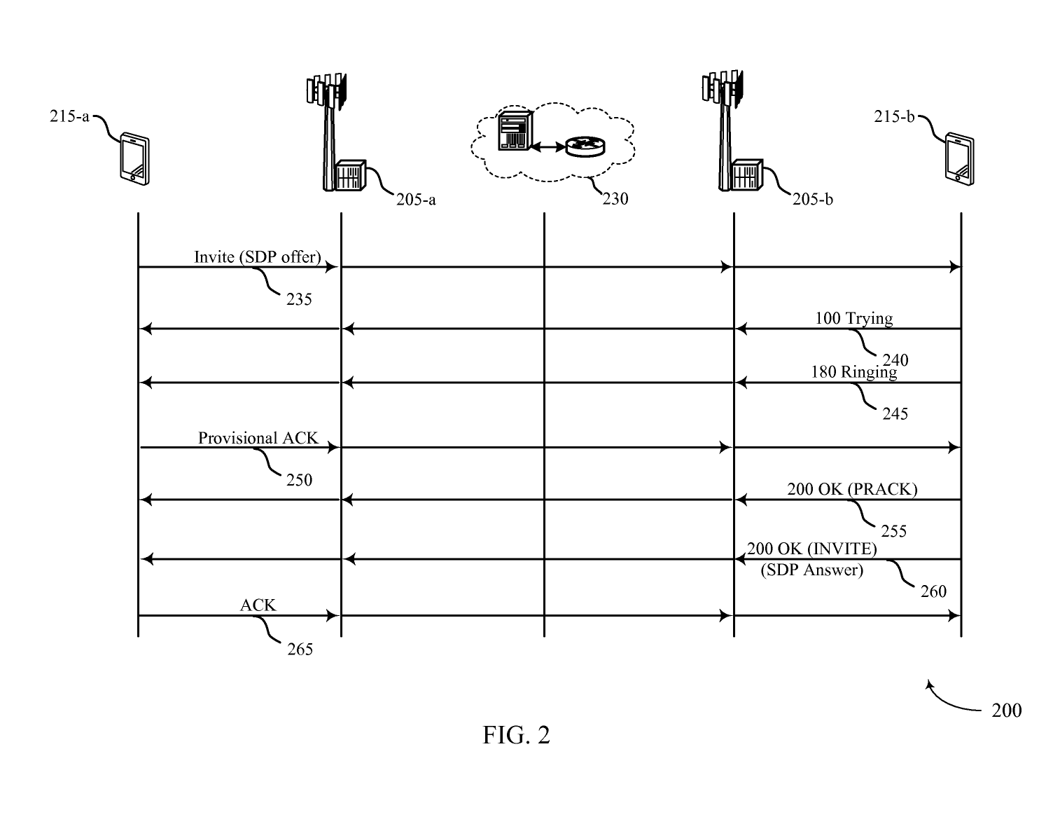

FIG. 2 illustrates an example of a communication flow 200 in a wireless communications system, in accordance with various aspects of the present disclosure. The communication flow 200 may be between a first UE 215-a that initiates a session, a first base station 205-a, a core network 230, a second base station 205-b, and a second UE 215-b that may be the subject of the session initiation, for example. The at least one base station 205 may be an example of the at least one base station 105 of FIG. 1, the UE 215 may be examples of the at least one UE 115 of FIG. 1, and the core network 230 may be an example of the core network 130 of FIG. 1. While the communication flow 200 illustrates communication between a first UE 215-a and a second UE 215-b via base stations 405 and core network 230, the communications shown need not be limited to the illustrated combination. For example, other communication flows may exist between UEs 215, between UEs 215 and base stations 405, or between UEs 215 and other network entities of the wireless communications network (e.g., wireless communications system 100 of FIG. 1).

In communication flow 200, the first UE 215-a first transmits an Invite (i.e., session description protocol (SDP) offer) session initiation message 235 that may be transmitted to the second UE 215-b via the first base station 205-a, core network 230, and second base station 205-b. The Invite (SDP offer) session initiation message 235 may be transmitted according to the SIP protocol, for example. In some examples, such an Invite (SDP offer) session initiation message 235 may be compressed using a template that may reduce the amount of data transmitted relative to an uncompressed Invite (SDP offer) session initiation message 235. An uncompressed Invite (SDP offer) session initiation message 235 may include one or more header field names and associated header field values, such as, for example:

Request-Line: INVITE tel:12018411563;phone-context=vzims.com SIP/2.0

f: “QC”<sip:+12018411623@vzims.com>;tag=289716713

t: <tel:12018411563;phone-context=vzims.com>

It will be readily understood that the above example is but one example of an SIP Invite message for a voice call for an operator. For the operator, some parts of session initiation messages remain constant across different instances of the same message (e.g., the SIP Invite (SDP offer) session initiation message 235). Continuing with the above example, the underlined portions of the below Invite (SDP offer) session initiation message 235 may remain constant across different instances of the message:

Request-Line: INVITE tel:12018411563;phone-context=vzims.com SIP/2.0

f: “QC”<sip:+12018411623@vzims.com>;tag=289716713

t: <tel:12018411563;phone-context=vzims.com>

Thus, such an initiation message may include two portions, a uniform portion that may include underlined content in this example, and a varying portion that may include the other content of this example. According to various examples, a template may be provided for such an Invite (SDP offer) session initiation message 235 for an operator, that may identify the session initiation message as an Invite message, and include the varying portion of the message. In such examples, the following information, including information from the varying portion, may be transmitted in a compressed Invite (SDP offer) session initiation message 235:

[template ID] tel:12018411563; sip:+12018411623; 289716713; tel:12018411563.

The [template ID] may be an identification of the template, and the remaining portions of the compressed Invite (SDP offer) session initiation message 235 may contain the varying portion of the message. In such a manner, the amount of data transmitted using radio frequency resources may be reduced. Information transmitted using session initiation messages, such as SIP messages, in some cases may include a payload such as SDP offer/answer for voice/video capabilities, which can also be compressed using templates according to various examples. Session initiation messages which do not contain a payload may use a common template between voice and video, in some examples. As noted above, a template may be identified by a template ID, which may signal the template used for compression/decompression. In some examples, one template may be provided for each of a number of different session initiation messages. For example, templates may be provided for each SIP request message INVITE (voice/video), acknowledgement (ACK), CANCEL, BYE, UPDATE (voice/video), PRACK, MESSAGE, REFER, INFO, OPTIONS, REGISTER and the most used responses 100 Trying, 180 Ringing, 183 Session Progress (voice/video), 200 OK with no SDP body, 200 OK with SDP body (voice/video). In such examples, approximately 20 template IDs would be provided for each operator, although it is to be understood that this is but one example and numerous other implementations may be utilized as will be readily recognized by one of skill in the art.

Continuing with the example of FIG. 2, Invite (SDP offer) session initiation message 235 may be transmitted from the first UE 215-a to the first base station 205-a as a compressed Invite (SDP offer) session initiation message 235. The first base station 205-a may decompress the Invite (SDP offer) session initiation message 235, and forward the message to second base station 205-b, which may or may not compress the Invite (SDP offer) session initiation message 235 when it is transmitted to the second UE 215-b based on whether the operator of the second base station 205-b utilizes templates for session initiation message compression, whether the second UE 215-b supports such compression, or whether such compression is enabled or disabled if compression is supported.

In some examples, the templates may be pre-loaded and statically configured at the UE 215 and at least one base station 205, such as by a Proxy-Call Session Control Function (P-CSCF). In other examples, the P-CSCF may learn the templates based on receiving one or more of a particular message type, and determining the contents of the particular message type and the associated template. The P-CSCF may, in such examples, push the learned templates to UEs 215 and at least one base station 205, such as via the Open Mobile Alliance (OMA) Device Management (DM) protocol for example. Learning templates may provide semi-static configuration of templates, and may allow for templates to change, such as a software upgrade, for example.

With continued reference to FIG. 2, the second UE 215-b may transmit a 100 Trying message 240 to first UE 215-a via second base station 205-b, core network 230, and first base station 205-a. The 100 Trying message 240 may be compressed when transmitted between second UE 215-b and second base station 205-b and/or when transmitted between first base station 205-a and first UE 215-a, using a template associated with the 100 Trying message 240, in a manner similar as discussed with respect to the Invite session initiation message 235. The second UE 215-b may then transmit a 180 Ringing message 245 to first UE 215-a via second base station 205-b, core network 230, and first base station 205-a, which also may be compressed in a similar manner. The first UE 215-a may transmit a provisional acknowledgment (PRACK) message 250 to the second UE 215-b via first base station 205-a, core network 230, and second base station 205-b, which also may be similarly compressed using a template associated with the PRACK message 250. The second UE 215-b may then transmit a 200 OK (PRACK) message 255 to first UE 215-a via second base station 205-b, core network 230, and first base station 205-a, which also may be compressed in a similar manner. The second UE 215-b may then transmit a 200 OK (Invite) (SDP answer) message 260 to first UE 215-a via second base station 205-b, core network 230, and first base station 205-a, which also may be compressed in a similar manner. Finally the first UE 215-a may transmit an ACK message 265 to the second UE 215-b via first base station 205-a, core network 230, and second base station 205-b, which also may be similarly compressed using an associated template. Following the ACK message 265, voice data may be transmitted between the first UE 215-a and second UE 215-b according to established protocols.

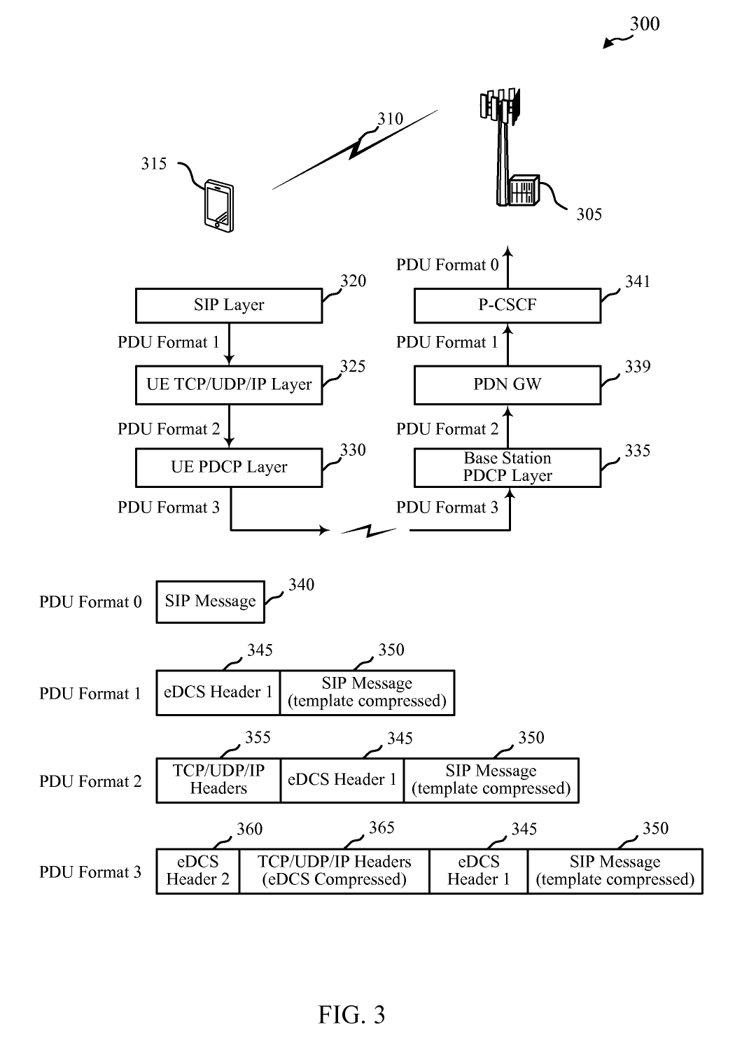

FIG. 3 illustrates an example of a wireless communications system that transmits session initiation messages using compression templates, in accordance with various aspects of the present disclosure. For example, FIG. 3 may illustrate an example of a wireless communications subsystem 300 used for eDCS. Wireless communications subsystem 300 may include UE 315, which may be an example of a UE 115 or a UE 215 described with reference to FIG. 1 or FIG. 2, respectively. Wireless communications subsystem 300 may also include a base station 305, which may be an example of a base station 105 or a base station 205 described above with reference to FIG. 1 or FIG. 2, respectively. Additionally, base station 305 may communicate with UE 315 via communication link 310. Communication link 310 may allow for bidirectional communication between the UE 315 and the base station 305 via a downlink and an uplink, as described with respect to FIG. 1. For instance, the base station 305 may transmit control and data information to the UE 315 in resource blocks (RBs) on a downlink.

As mentioned above, UE 315 and base station 305 may transmit session initiation messages using compression templates. In examples such as illustrated in FIG. 3, session initiation messages may be compressed and decompressed at an IMS stack using templates in UE 315 and in a P-CSCF. In this example, a SIP layer 320 may generate a session initiation message and provide the session initiation message in a protocol data unit (PDU). A number of different format PDUs may be provided, including PDU format 0 which may include an uncompressed SIP message 340, for example. PDU format 1 may include a template compressed SIP message 350, and an eDCS header 1 345, which may contain a template ID of the template used to compress the template compressed SIP message 350. In the example of FIG. 3, SIP layer 320 at UE 315 provides a PDU format 1 to a UE TCP/UDP/IP layer 325. The UE TCP/UDP/IP layer 325 may add one or more TCP/UDP/IP headers 355 to the PDU, to generate a PDU having PDU format 2, which may be provided to a UE packet data convergence protocol (PDCP) layer 330.

UE packet data convergence protocol (PDCP) layer 330, in some examples, may perform compression at a PDCP level on packets transmitted from the UE 315, and in some examples may perform an eDCS on data packets, and generate a PDU with PDU format 3 with eDCS compressed TCP/UDP/IP headers 365 and an eDCS header 2 360. The eDCS header 2 360 may contain, for example, eDCS context data for string matches used in the eDCS for compressing the associated data. Thus, eDCS header compression in such examples may occur independently of session initiation message template compression.

The compressed PDU may be transmitted to the base station 305, which may receive the PDU format 3 data at base station PDCP layer 335. The base station PDCP layer may decompress the data using eDCS, and generate PDU format 2 data which may be provided to packet data network (PDN) gateway (GW) 339. The PDN GW 339 may process the data, and remove TCP/UDP/IP headers 355 to provide PDU format 1 data to P-CSCF 341, which may decompress the template compressed SIP message 350 and provide a decompressed PDU format 0 uncompressed SIP message 340 to the appropriate network entity. While an uplink session initiation message transmission is discussed in the example of FIG. 3, similar techniques may be used for downlink transmissions of compressed data, in which a base station 305 may compress data and a UE 315 may decompress data in a reverse order of the above described operations. In some examples, session initiation message compression using templates may be enabled/disabled for a UE 315 during IMS registration. For example, an indication that template-based compression is enabled may be provided to P-CSCF 441 during registration of the UE 315, and the P-CSCF 441 may confirm that template-based compression is to be used in a responsive message to the UE 315.

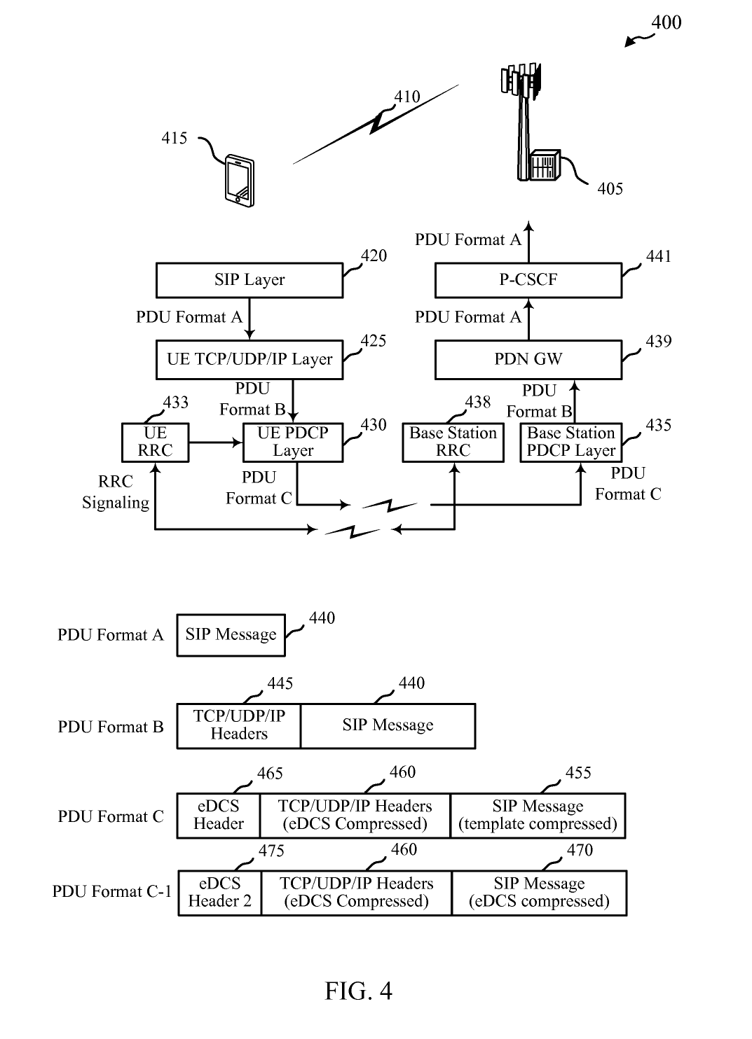

FIG. 4 illustrates an example of a wireless communications system that transmits session initiation messages using compression templates, in accordance with various aspects of the present disclosure. For example, FIG. 4 may illustrate an example of a wireless communications subsystem 400 used for eDCS. Wireless communications subsystem 400 may include UE 415, which may be an example of a UE 115 or 215 described with reference to FIG. 1 or FIG. 2, respectively. Wireless communications subsystem 400 may also include a base station 405, which may be an example of a base station 105 or a base station 205 described above with reference to FIG. 1 or FIG. 2, respectively. Additionally, base station 405 may communicate with UE 415 via communication link 410. Communication link 410 may allow for bidirectional communication between the UE 415 and the base station 405 via a downlink and an uplink, as described with respect to FIG. 1. For instance, the base station 405 may transmit control and data information to the UE 415 in resource blocks (RBs) on a downlink.

As mentioned above, UE 415 and base station 405 may transmit session initiation messages using compression templates. In examples such as illustrated in FIG. 4, session initiation messages may be compressed and decompressed at the PDCP layer using templates in UE 415 and in base station 405. In this example, a SIP layer 420 may generate a session initiation message and provide the session initiation message in a protocol data unit (PDU). A number of different format PDUs may be provided, including PDU format A which may include an uncompressed SIP message 440, for example. PDU format B may include SIP message 440, and TCP/UDP/IP headers 445. In the example of FIG. 4, SIP layer 420 at UE 415 provides a PDU format A to a UE TCP/UDP/IP layer 425. The UE TCP/UDP/IP layer 425 may add one or more TCP/UDP/IP headers 445 to the PDU, to generate a PDU having PDU format B, which may be provided to a UE packet data convergence protocol (PDCP) layer 430.

UE PDCP layer 430, in some examples, may perform template-based compression of SIP message 440, and also may perform compression at a PDCP level on packets transmitted from the UE 415, and in some examples may perform an eDCS on data packets, and generate a PDU with PDU format C with eDCS compressed TCP/UDP/IP headers 460, a template compressed SIP message 455, and an eDCS header 465. The eDCS header 465 may contain, for example, eDCS context data for string matches used in the eDCS for compressing the eDCS compressed TCP/UDP/IP headers 460, and may contain a template ID for the template used to compress template compressed SIP message 455. Furthermore, eDCS header 465 may include an indication of header length of the compressed TCP/UDP/IP headers 460. In some examples, rather than having an indication of header length of the compressed TCP/UDP/IP headers 460, a received packet may be examined until it is determined that a fixed SIP message (Request-Line/Status-Line) is found, and the SIP message may be examined to find a SIP message name and hence template ID for use in decompressing the template compressed SIP message 455.

The compressed PDU may be transmitted to the base station 405, which may receive the PDU format C data at base station PDCP layer 435. The base station PDCP layer 435 may decompress the data using eDCS, and generate PDU format B data which may be provided to PDN GW 439. The PDN GW 439 may process the data, and remove TCP/UDP/IP headers 445 to provide PDU format A data to P-CSCF 441, which may provide the decompressed PDU format A SIP message 440 to the appropriate network entity. While an uplink session initiation message transmission is discussed in the example of FIG. 4, similar techniques may be used for downlink transmissions of compressed data, in which a base station 405 may compress data and a UE 415 may decompress data in a reverse order of the above described operations. In some examples, session initiation message compression using templates may be enabled/disabled for a UE 415 during RRC signaling between base station RRC component 438 and UE RRC component 433. RRC signaling from the UE 415 may indicate that the UE 415 is capable of template based compression, and the base station 405 may confirm that template-based compression is enabled in a responsive RRC message.

In some examples, template-based compression of session initiation messages may be performed at the PDCP layer using an eDCS. In such examples, the eDCS may include a static buffer that may include compression templates for use in compressing session initiation messages. In such examples, the UE PDCP layer 430 may applies eDCS compression on TCP/UDP/IP headers 445 and apply template-based compression on the SIP message 440 using an eDCS algorithm and the template stored in the static buffer, and generate data with PDU format C-1. PDU format C-1 may include eDCS header 2 475, eDCS compressed TCP/UDP/IP headers 460, and eDCS compressed SIP message 470. The eDCS header 2 475, in some example, may include a header with a context ID indicating a dynamic buffer for use in compression of TCP/UDP/IP headers 445 and a second context ID indicating a static buffer (e.g., template ID) for use in compression of SIP message 440. The base station PDCP layer 435 may receive and process the eDCS header 2 475, and perform decompression using the indicated dynamic and static buffers. For example, string matches of the dynamic buffer may be used for decompression of eDCS compressed TCP/UDP/IP headers 460, and a template ID of the static buffer may be used to decompress eDCS compressed SIP message 470.

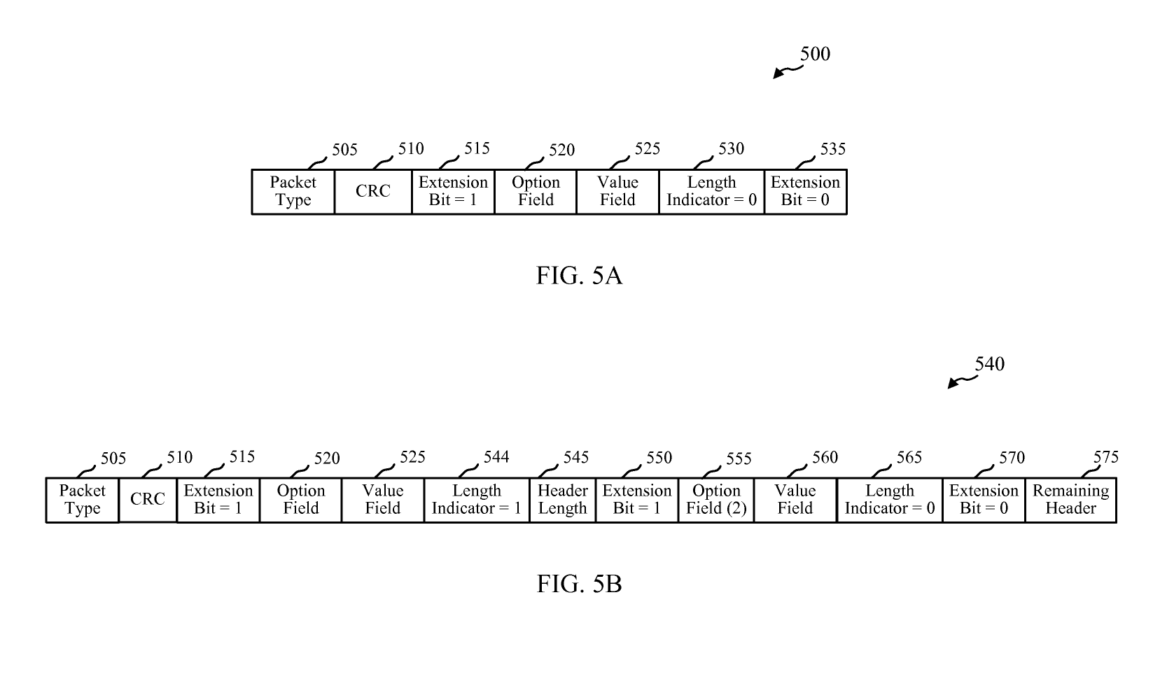

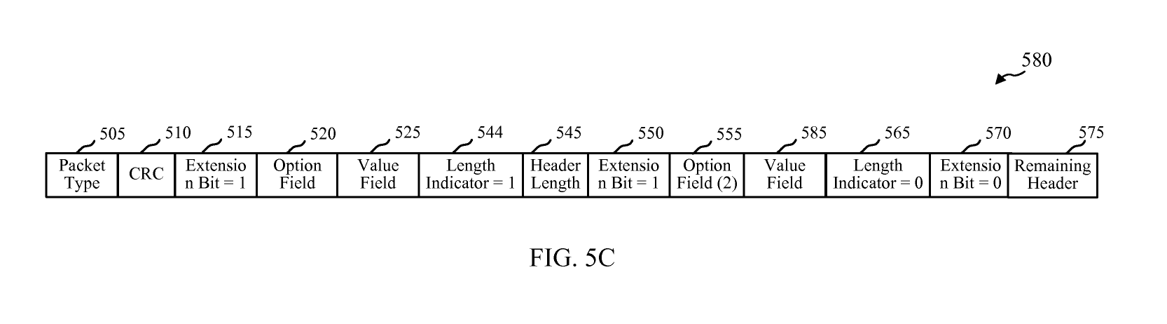

As mentioned above, various different headers may be used in different examples for eDCS compression. FIG. 5A illustrates an example of an eDCS header 500, in accordance with various aspects of the present disclosure. The eDCS header 500 may be transmitted between a UE (e.g., UE 115, 215, 315, 415 of FIG. 1, 2, 3 or 4) and a base station (e.g., base station 105, 205, 305, 405 of FIG. 1, 2, 3 or 4). In other cases, the eDCS header 500 may be used for communications between other wireless devices (e.g., between two UEs 115). The eDCS header 500 may include fields for conveying information regarding compression scheme, compression context, and the presence or absence of additional header extension fields. Although the fields of eDCS header 500 are shown in an order, the fields may be arranged in alternate orders. Additionally, some of the fields may be absent (e.g., only a portion of the fields may be included in a header extension).

The eDCS header 500 may be transmitted from one wireless device to another and may be used to convey data, as well as control information, which the receiving wireless device may use to configure itself to facilitate proper reception of communications from the transmitting device. For example, the eDCS header 500 may include a packet type field 505 which may indicate whether or not compression has been enabled. Packet type field 505 may be followed by a cyclic redundancy check (CRC) field 510, which may be used to detect errors in the eDCS header 500. Additionally, eDCS header 500 may include an extension field 515, which may indicate the absence or presence of the header extension which may include option field 520 and a value field 525. The option field 520 may be used to convey information relating to various compression-related options. The conveyed information may relate to specific actions that the receiver of the eDCS header 500 may take, or may provide details regarding how compression is to be or has been applied to a data packet. A number of different options may be conveyed.

For example, the option field 520 may be used to convey that a context ID is to be used for some segment of the payload by the transmitter. Thus, a receiving entity will know that a context ID may be used for some part of a payload, such as a payload associated with a SIP message, for example. In this example, the value field 525 may include the compression context identification (ID) which corresponds to the desired compression context. In this example, the value field 525 may include an indication of the template ID used for compression of a session initiation message. A length indicator field 530 may include information related to the length of a header, and a further extension bit 535 may be used to indicate, in this example, the absence of a further header extension. eDCS header 500 may be used, in some examples, when compression is performed at the SIP layer, such as described with respect to FIG. 3.

FIG. 5B illustrates another example of an eDCS header 540, in accordance with various aspects of the present disclosure. The eDCS header 540 may be transmitted between a UE (e.g., UE 115, 215, 315, 415 of FIG. 1, 2, 3 or 4) and a base station (e.g., base station 105, 205, 305, 405 of FIG. 1, 2, 3 or 4). In other cases, the eDCS header 540 may be used for communications between other wireless devices (e.g., between two UEs 115). The eDCS header 540 may precede a payload that is either compressed or uncompressed. The eDCS header 540 may include fields for conveying information regarding compression scheme, compression context, and the presence or absence of additional header extension fields. Although the fields of eDCS header 540 are shown in an order, the fields may be arranged in alternate orders. Additionally, some of the fields may be absent (e.g., only a portion of the fields may be included in a header extension).

The eDCS header 540 may be transmitted from one wireless device to another and may be used to convey data, as well as control information, which the receiving wireless device may use to configure itself to facilitate proper reception of communications from the transmitting device. For example, the eDCS header 540 may include a packet type field 505, CRC field 510, extension field 515, and option field 520 similarly as discussed above with respect to FIG. 5A. In this example, eDCS header 540 may include dynamic buffer information in value field 525, and a length indicator field 544 may indicate that header length field 545 includes information on header length. A further extension field 550 may have a bit set to indicate a further header extension and a second option field 555 may be used to convey information relating to various further compression-related options, such as template-based compression. Value field 560, in this example, may contain a template ID used for template-based compression of a session initiation message. In this example, eDCS header 540 may include a second length indicator 565 that may be set to zero, and a second extension field 570 that may be set to zero, indicating that further extensions are not present. Remaining eDCS header 575 is included, which may include additional information related to dynamic compression, for example. The eDCS header 540 may be used, in some examples, when compression is performed at the PDCP layer, such as described with respect to FIG. 4.

FIG. 5C illustrates another example of an eDCS header 580, in accordance with various aspects of the present disclosure. In this example, the eDCS header 580 may also be used when compression is performed at the PDCP layer, and when template-based compression of session initiation messages is using an eDCS. In this example, the fields of eDCS header 580 correspond to the fields of eDCS header 540, with the exception of value field 585, which in this example may contain static eDCS buffer information that may include a template used for template-based compression of a session initiation message.

In some examples, session initiation messages may be further compressed using eDCS for the fields which are not part of a template but still may be are repeated, such as, for example, IP addresses and SIP URI's, which may be semi-static in that the same values may be transmitted by a UE. Thus, semi-static fields may be UE specific while the static fields of a template may be the same across different UEs (e.g., UE 115, 215, 315, 415 of FIG. 1, 2, 3, or 4). In some examples, these semi-static fields may be compressed in the PDCP layer at UE and base station, in addition to templates being applied in the IMS stack in UE, and at the P-CSCF on the network side, in a manner similar as discussed above with respect to FIG. 3. In some examples, session initiation message semi-static compression may occur at the PDCP layer with a semi-static session initiation message buffer which may contain templates updated with the semi-static fields. This semi-static compression may be applied on a template compressed PDU, and the semi-static buffers may be common for all session initiation messages for a UE. Decompression of such further compressed session initiation messages may be performed in reverse order, namely first eDCS decompression at the PDCP layer and then template based decompression at P-CSCF. In examples where template-based compression is performed at the PDCP layer (such as discussed above with respect to FIG. 4), session initiation message compression for static and semi-static compression may occur at the at PDCP layer, and a semi-static SIP buffer may be provided which contains templates updated with semi-static fields.

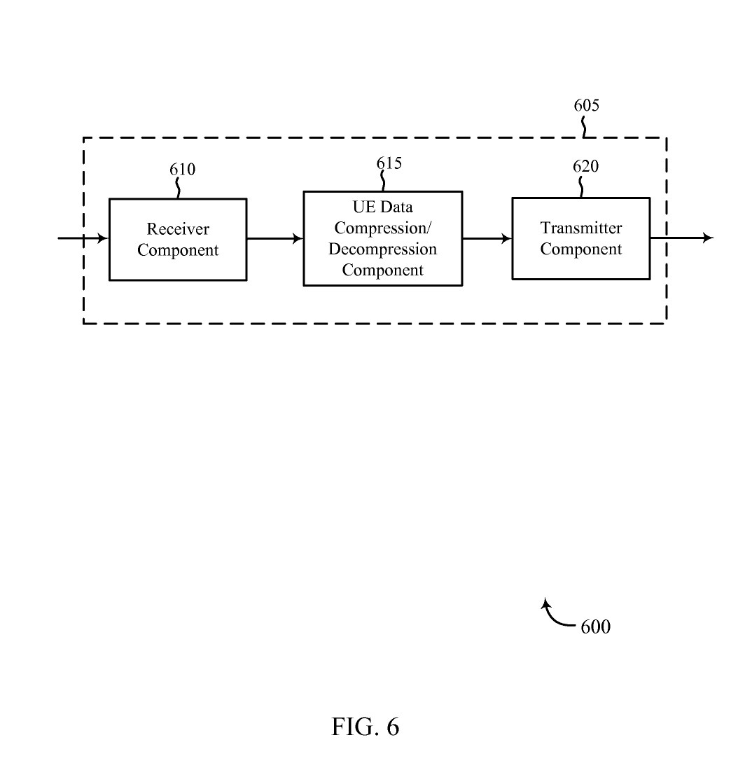

FIG. 6 shows a block diagram 600 of a device 605 for use in wireless communications, in accordance with various aspects of the present disclosure. The device 605 may be an example of one or more aspects of a UE 115, 215, 315, or 415 described with reference to one or more of FIG. 1, 2, 3 or 4. The device 605 may include a receiver component 610, a UE data compression/decompression component 615, and/or a transmitter component 620. The device 605 may also be or include a processor (not shown). Each of these components may be in communication with each other.

The components of the device 605 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by one or more general or application-specific processors.

The receiver component 610 may receive information such as packets, user data, and/or control information associated with various information channels (e.g., control channels, data channels, etc.). The receiver component 610 may be configured to receive compressed data packets and signaling information. Information may be passed on to the UE data compression/decompression component 615, and to other components of the device 605. In some examples, the information may include data compression information related to initiating or continuing data compression on transmitted/received packets.

The UE data compression/decompression component 615 may receive session initiation messages and compress the session initiation messages according to template-based data compression, in a manner similarly as discussed above with respect to FIGS. 1-5.

The transmitter component 620 may transmit the one or more signals received from other components of the device 605. The transmitter component 620 may transmit, for example, compressed data packets to a base station over a wireless link, in a manner similarly as discussed above. In some examples, the transmitter component 620 may be collocated with the receiver component 610 in a transceiver component.

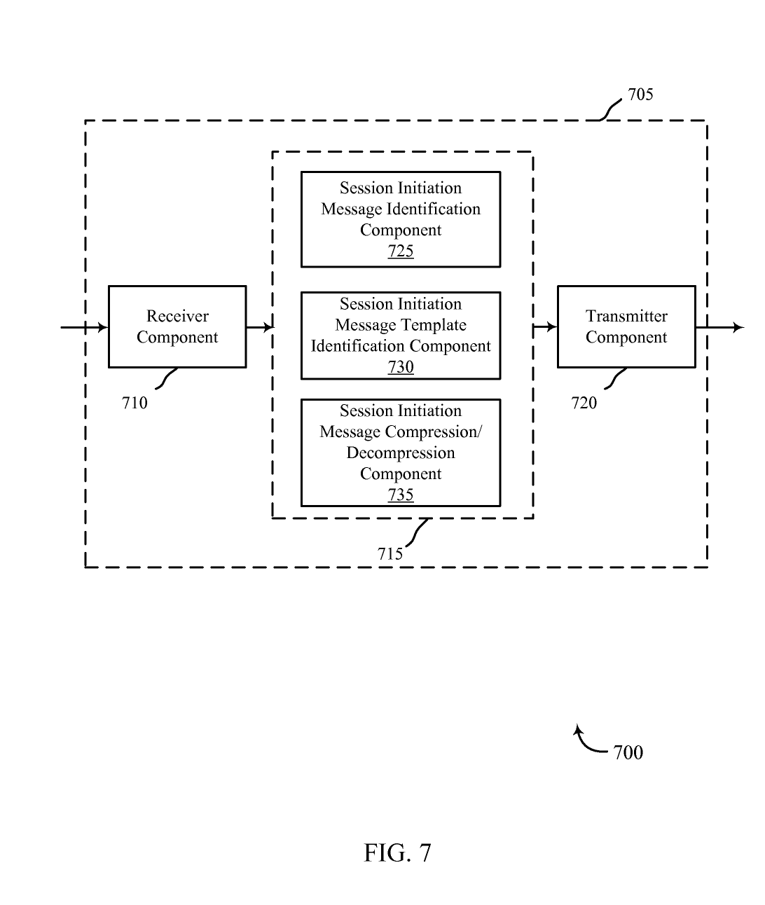

FIG. 7 shows a block diagram 700 of a device 705 for use in wireless communications, in accordance with various aspects of the present disclosure. The device 705 may be an example of one or more aspects of a UE 115, 215, 315, or 415 described with reference to one or more of FIG. 1, 2, 3 or 4. It may also be an example of a device 605 described with reference to FIG. 6. The device 705 may include a receiver component 710, a UE data compression/decompression component 715, and/or a transmitter component 720, which may be examples of the corresponding components of device 605. The device 705 may also include a processor (not shown). Each of these components may be in communication with each other. The UE data compression/decompression component 715 may include a session initiation message identification component 725, a session initiation message template identification component 730, and a session initiation message compression/decompression component 735. The receiver component 710 and the transmitter component 720 may perform the functions of the receiver component 610 and the transmitter component 620, of FIG. 6, respectively.

The session initiation message identification component 725 may identify session initiation messages according to a message type of the session initiation message, as discussed above with respect to FIGS. 1-4. The message type may be used by the session initiation message template identification component 730 to identify a particular template for use in compressing the session initiation message, as discussed above with respect to FIGS. 1-4. The session initiation message compression/decompression component 735 may perform compression of session initiation messages by extracting at least a portion of contents of the identified template from the session initiation message, as discussed above with respect to FIGS. 1-4. The session initiation message compression/decompression component 735 may also generate eDCS headers in a manner such as discussed above with respect to FIGS. 1-5.

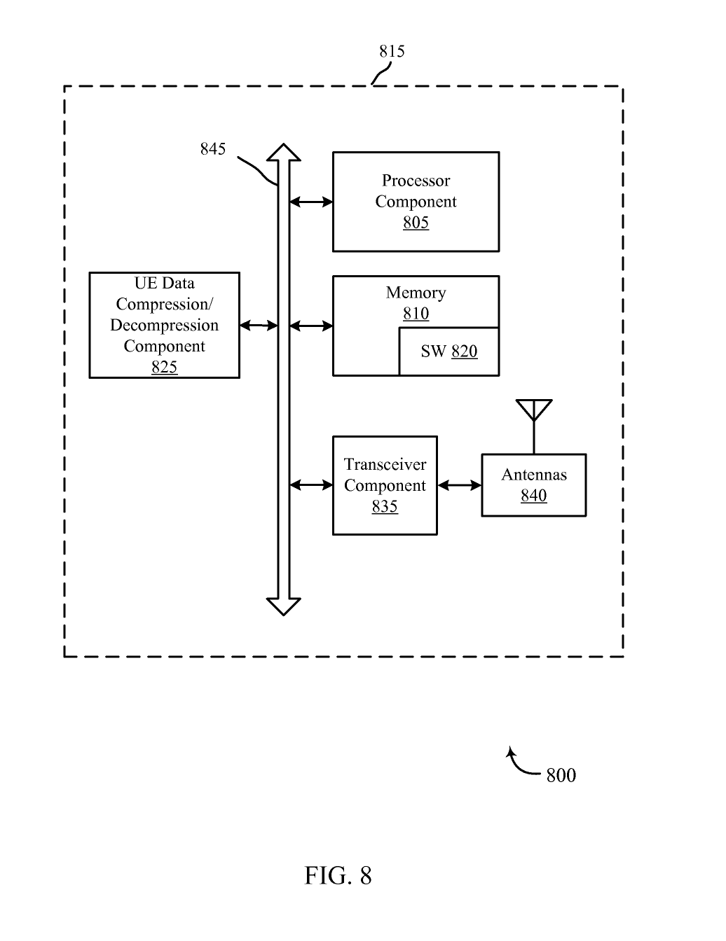

FIG. 8 shows a system 800 for use in wireless communications, in accordance with various aspects of the present disclosure. System 800 may include a UE 815, which may be an example of UE 115, 215, 315 or 415 of one or more of FIG. 1, 2, 3 or 4. UE 815 may also be an example of one or more aspects of device 605 or device 705 of FIG. 6 or 7.

The UE 815 may, for example, include components for bi-directional voice and data communications including components for transmitting communications and components for receiving communications. The UE 815 may include at least one antenna 840, a transceiver component 835, a processor component 805, and memory 810 (including software (SW) 820), which each may communicate, directly or indirectly, with each other (e.g., via one or more buses 845). The transceiver component 835 may be configured to communicate bi-directionally, via the at least one antenna 840 and/or one or more wired or wireless links, with one or more networks, as described above. For example, the transceiver component 835 may be configured to communicate bi-directionally with base station 105, 205, 305, or 405 with reference to FIG. 1, 2, 3, or 4. The transceiver component 835 may include a modem configured to modulate the packets and provide the modulated packets to the at least one antenna 840 for transmission, and to demodulate packets received from the at least one antenna 840. While the UE 815 may include at least one antenna 840, the UE 815 may have multiple antennas 840 capable of concurrently transmitting and/or receiving multiple wireless transmissions. The transceiver component 835 may be capable of concurrently communicating with one or more base stations (e.g., base station 105, 205, 305, or 405 of FIG. 1, 2, 3, or 4) via multiple component carriers.

The UE 815 may include a UE data compression/decompression component 825, which may perform the functions described above for the UE data compression/decompression component 615 or data compression/decompression component 715 of device 605 or device 705 of FIG. 6 or 7.

The memory 810 may include random access memory (RAM) and read-only memory (ROM). The memory 810 may store computer-readable, computer-executable software/firmware code 820 containing instructions that are configured to, when executed, cause the processor component 805 to perform various functions described herein (e.g., data compression, template determination, etc.). Alternatively, the computer-readable, computer-executable software/firmware code 820 may not be directly executable by the processor component 805 but be configured to cause a computer (e.g., when compiled and executed) to perform functions described herein. The processor component 805 may include an intelligent hardware device, e.g., a central processing unit (CPU), a microcontroller, an application-specific integrated circuit (ASIC), etc.

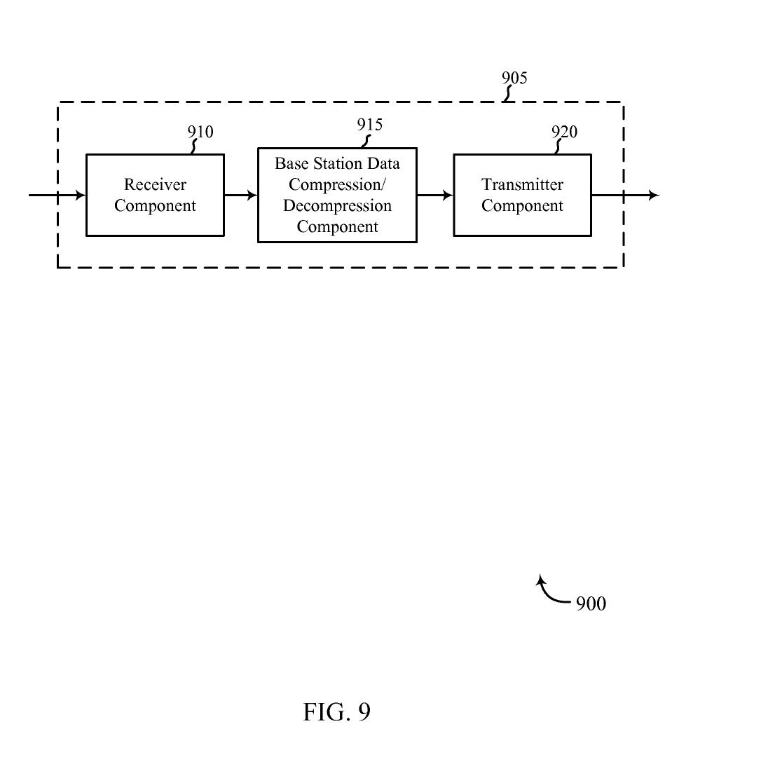

FIG. 9 shows a block diagram 900 of an apparatus 905 for use in wireless communications, in accordance with various aspects of the present disclosure. In some examples, the apparatus 905 may be an example of aspects of at least one of base station 105, 205, 305, or 405 described with reference to one or more of FIG. 1, 2, 3 or 4. In some examples, the apparatus 905 may be part or include an LTE/LTE-A eNB and/or an LTE/LTE-A base station. The apparatus 905 may also be a processor. The apparatus 905 may include a receiver component 910, a base station data compression/decompression component 915, and/or a transmitter component 920. Each of these components may be in communication with each other.

The components of the apparatus 905 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by one or more general or application-specific processors.

In some examples, the receiver component 910 may include at least one radio frequency (RF) receiver, such as an RF receiver operable to receive compressed data packets from one or more UEs. The receiver component 910 may be used to receive various types of data and/or control signals (i.e., transmissions) over one or more communication links of a wireless communications system, such as one or more communication links of the wireless communications system 100, wireless communications subsystem 300 or wireless communications subsystem 400 described with reference to FIG. 1, 3 or 4.

In some examples, the transmitter component 920 may include at least one RF transmitter, such as at least one RF transmitter operable to transmit information related to data compression and compressed data, in a manner similarly as discussed above with respect to FIGS. 1-5. The transmitter component 920 may be used to transmit various types of data and/or control signals (i.e., transmissions) over one or more communication links of a wireless communications system, such as one or more communication links of the wireless communications system 100, wireless communications subsystem 300 or wireless communications subsystem 400 described with reference to FIG. 1, 3 or 4. In some examples, the base station data compression/decompression component 915 may perform template-based data compression operations and determinations such as discussed above with respect to FIGS. 1-5.

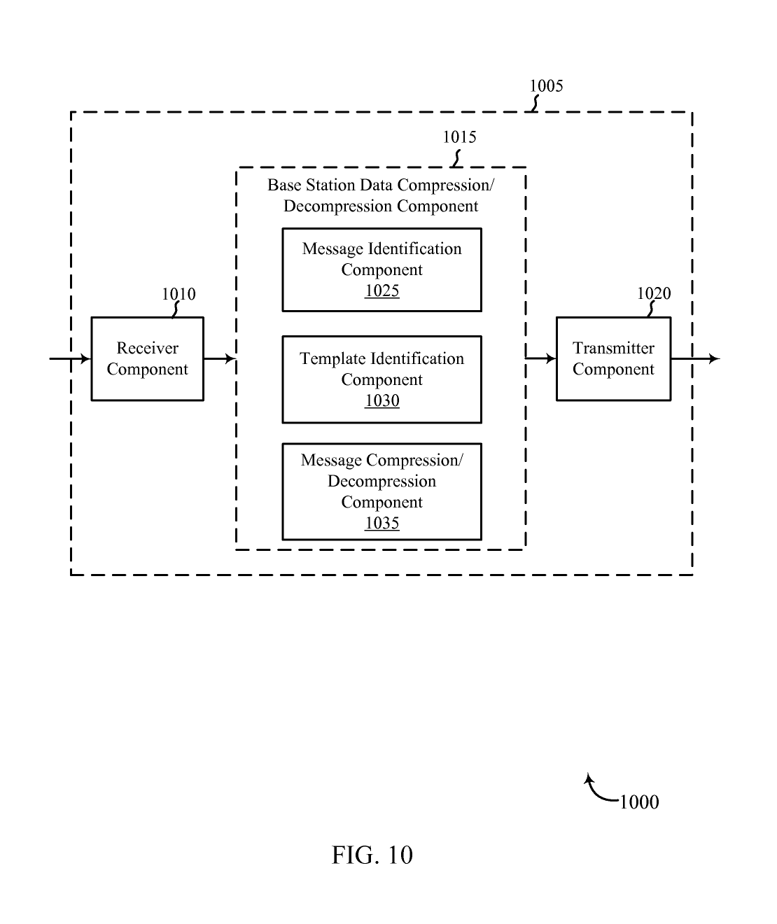

FIG. 10 shows a block diagram 1000 of an apparatus 1005 for use in wireless communications, in accordance with various aspects of the present disclosure. In some examples, the apparatus 1005 may be an example of aspects of at least one of base station 105, 205, 305, or 405 described with reference to one or more of FIG. 1, 2, 3 or 4, and/or an example of aspects of the apparatus 905 described with reference to FIG. 9. In some examples, the apparatus 1005 may be part or include an LTE/LTE-A eNB and/or an LTE/LTE-A base station. The apparatus 1005 may also be a processor. The apparatus 1005 may include a receiver component 1010, a base station data compression/decompression component 1015, and/or a transmitter component 1020. Each of these components may be in communication with each other.

The components of the apparatus 1005 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by one or more general or application-specific processors.

In some examples, the receiver component 1010 may be an example of one or more aspects of the receiver component 910 described with reference to FIG. 9. In some examples, the receiver component 1010 may include at least one radio frequency (RF) receiver, such as at least one RF receiver operable to receive compressed data packets. The receiver component 1010 may be used to receive various types of data and/or control signals (i.e., transmissions) over one or more communication links of a wireless communications system, such as one or more communication links of the wireless communications system 100, wireless communications subsystem 300, or wireless communications subsystem 400 described with reference to FIG. 1, 3, or 4.

In some examples, the transmitter component 1020 may be an example of one or more aspects of the transmitter component 920 described with reference to FIG. 9. In some examples, the transmitter component 1020 may include at least one RF transmitter, such as at least one RF transmitter operable to transmit compressed data packets and control information related to the use of data compression routines (e.g., eDCS). The transmitter component 1020 may be used to transmit various types of data and/or control signals (i.e., transmissions) over one or more communication links of a wireless communications system, such as one or more communication links of the wireless communications system 100, wireless communications subsystem 300, or wireless communications subsystem 400 described with reference to FIG. 1, 3, or 4.

In the example of FIG. 10, the base station data compression/decompression component 1015 includes a message identification component 1025, a template identification component 1030, and a message compression/decompression component 1035. The message identification component 1025, in some examples, may identify session initiation messages that are to be transmitted, or are received, in a manner similarly as discussed above with respect to FIGS. 1-5. The template identification component 1030 may identify a template associated with a particular type of session initiation message, the identified template for use in compressing/decompressing a session initiation message, in a manner similarly as discussed above with respect to FIGS. 1-5. The message compression/decompression component 1035 may perform session initiation message compression/decompression of template-compressed session initiation messages, in a manner similarly as discussed above with respect to FIGS. 1-5.

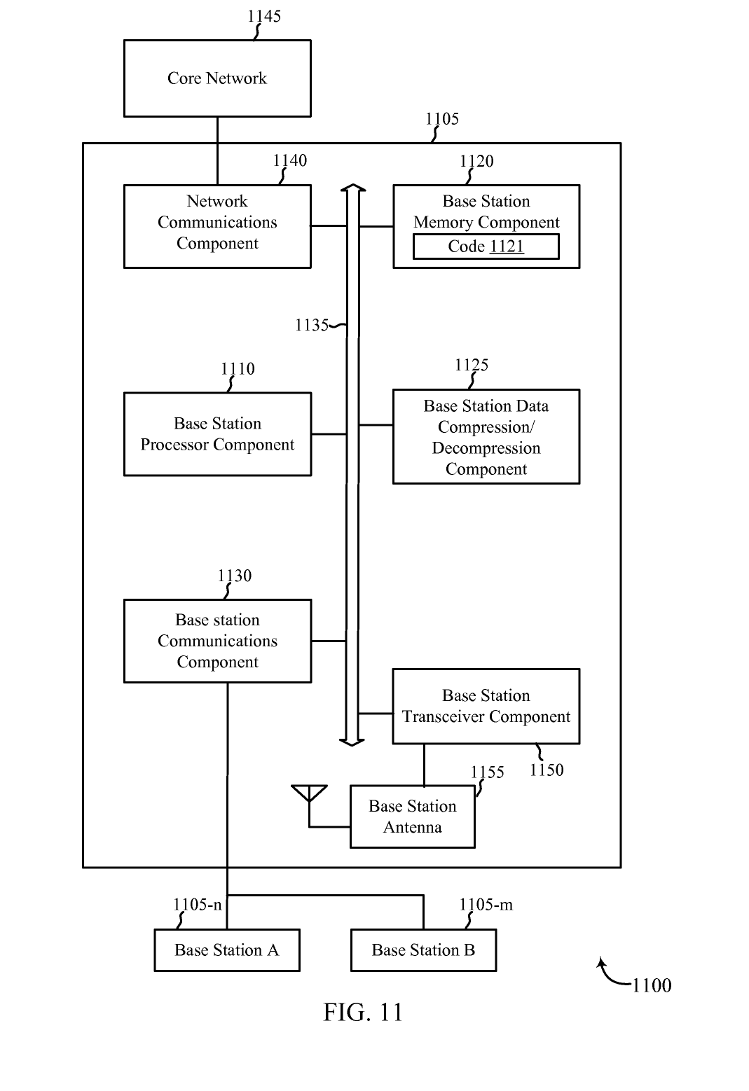

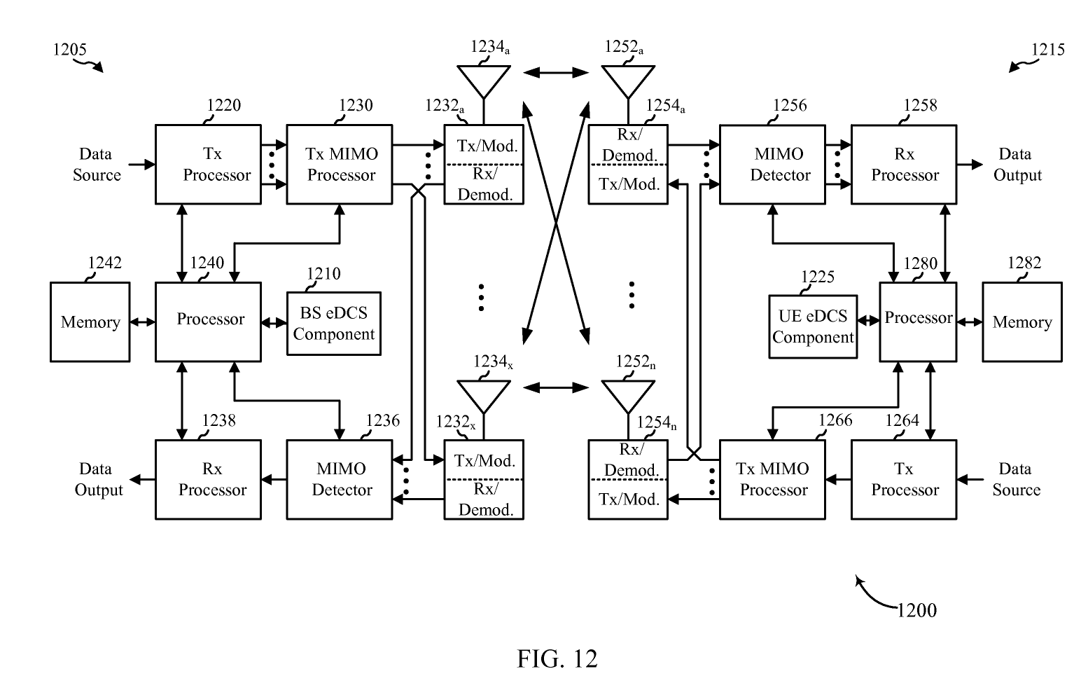

FIG. 11 shows a block diagram 1100 of a base station 1105 (e.g., a base station forming part or all of an eNB) for use in wireless communications, in accordance with various aspects of the present disclosure. In some examples, the base station 1105 may be an example of aspects of at least one of base station 105, 205, 305, or 405 described with reference to one or more of FIG. 1, 2, 3 or 4, and/or aspects of one or more of apparatus 905 or apparatus 1005 when configured as a base station, as described with reference to FIG. 9 or 10. The base station 1105 may be configured to implement or facilitate at least some of the base station and/or apparatus features and functions described with reference to one or more of FIG. 1, 2, 3, 4, 5, 9 or 10.

The base station 1105 may include a base station processor component 1110, a base station memory component 1120, at least one base station transceiver component (represented by base station transceiver component 1150), at least one base station antenna (represented by base station antenna 1155), and/or a base station data compression/decompression component 915-b. The base station 105-a may also include at least one base station communications component 1130 and/or a network communications component 1140. Each of these components may be in communication with each other, directly or indirectly, over one or more buses 1135.

The base station memory component 1120 may include random access memory (RAM) and/or read-only memory (ROM). The base station memory component 1120 may store computer-readable, computer-executable software/firmware code 1121 containing instructions that are configured to, when executed, cause the base station processor component 1110 to perform various functions described herein related to wireless communications (e.g., data acceleration operations, etc.). Alternatively, the computer-readable, computer-executable software/firmware code 1121 may not be directly executable by the base station processor component 1110 but be configured to cause the base station 1105 (e.g., when compiled and executed) to perform various of the functions described herein.

The base station processor component 1110 may include an intelligent hardware device, e.g., a central processing unit (CPU), a microcontroller, an ASIC, etc. The base station processor component 1110 may process information received through the at least one base station transceiver component 1150, the base station communications component 1130, and/or the network communications component 1140. The base station processor component 1110 may also process information to be sent to the at least one base station transceiver component 1150 for transmission through the at least one base station antenna 1155, to the base station communications component 1130, for transmission to at least one of base station 1105-n and base station 1105-m, and/or to the network communications component 1140 for transmission to a core network 1145, which may be an example of one or more aspects of the core network 130 or 230 described with reference to FIG. 1 or 2. The base station processor component 1110 may handle, alone or in connection with the base station data compression/decompression component 1125, various aspects of session initiation message identification, compression, and decompression as discussed above wire respect to FIGS. 1-5.

The at least one base station transceiver component 1150 may include a modem configured to modulate packets and provide the modulated packets to the at least one base station antenna 1155 for transmission, and to demodulate packets received from the at least one base station antenna 1155. The at least one base station transceiver component 1150 may, in some examples, be implemented as one or more base station transmitter components and one or more separate base station receiver components. The at least one base station transceiver component 1150 may support communications in a first radio frequency spectrum band and/or a second radio frequency spectrum band. The at least one base station transceiver component 1150 may be configured to communicate bi-directionally, via the at least one base station antenna 1155, with one or more UEs or apparatuses, such as at least one of UE 115, 215, 315, 415, or 815 described with reference to FIG. 1-4 or 8. The base station 1105 may, for example, include multiple base station antennas 1155 (e.g., an antenna array). The base station 1105 may communicate with the core network 1145 through the network communications component 1140. The base station 1105 may also communicate with other base stations, such as base station 1105-n and base station 1105-m, using the base station communications component 1130.

The base station data compression/decompression component 1125 may be configured to perform and/or control some or all of the features and/or functions described with reference to FIGS. 1-5 related to data compression operations. The base station data compression/decompression component 1125, or portions of the base station data compression/decompression component 1125, may include a processor, and/or some or all of the functions of the base station data compression/decompression component 1125 may be performed by the base station processor component 1110 and/or in connection with the base station processor component 1110. In some examples, the base station data compression/decompression component 1125 may be an example of the base station data compression/decompression component 915 and/or 1015 described with reference to FIGS. 9 and/or 10.

FIG. 12 shows a block diagram of a multiple input/multiple output (MIMO) communications system 1200 including a base station 1205 and a UE 1215, in accordance with various aspects of the present disclosure. The MIMO communications system 1200 may illustrate aspects of the wireless communications system 100, wireless communications subsystem 300, or wireless communications subsystem 400 shown in FIG. 1, 3, or 4. The base station 1205 may be equipped with antennas 1234ₐ through 1234ₓ, and the UE 1215 may be equipped with UE antennas 1252ₐ through 1252ₙ. In the MIMO communications system 1200, the base station 1205 may be able to send data over multiple communication links at the same time. Each communication link may be called a “layer” and the “rank” of the communication link may indicate the number of layers used for communication. For example, in a 2×2 MIMO communications system where base station 1205 transmits two “layers,” the rank of the communication link between the base station 1205 and the UE 1215 is two.

At the base station 1205, a transmit processor 1220 may receive data from a data source. The transmit processor 1220 may process the data. The transmit processor 1220 may also generate control symbols and/or reference symbols. A transmit (TX) MIMO processor 1230 may perform spatial processing (e.g., precoding) on data symbols, control symbols, and/or reference symbols, if applicable, and may provide output symbol streams to the transmit modulators 1232ₐ through 1232ₓ. Each of the modulators 1232 may process a respective output symbol stream (e.g., for OFDM, etc.) to obtain an output sample stream. Each of the modulators 1232 may further process (e.g., convert to analog, amplify, filter, and upconvert) the output sample stream to obtain a DL signal. In one example, DL signals from modulators 1232ₐ through 1232ₓ may be transmitted via the antennas 1234ₐ through 1234ₓ, respectively.

At the UE 1215, the UE antennas 1252ₐ through 1252ₙ may receive the DL signals from the base station 1205 and may provide the received signals to the demodulators 1254ₐ through 1254ₙ, respectively. Each of the demodulators 1254 may condition (e.g., filter, amplify, downconvert, and digitize) a respective received signal to obtain input samples. Each of the demodulators 1254 may further process the input samples (e.g., for OFDM, etc.) to obtain received symbols. A MIMO detector 1256 may obtain received symbols from all the demodulators 1254ₐ through 1254ₙ, perform MIMO detection on the received symbols, if applicable, and provide detected symbols. A receive processor 1258 may process (e.g., demodulate, deinterleave, and decode) the detected symbols, providing decoded data for the UE 1215 to a data output, and provide decoded control information to a processor 1280, or memory 1282.

The processor 1280 may in some cases execute stored instructions to instantiate one or more of a UE eDCS component 1225. The UE eDCS component 1225 may be an example of aspects of the UE data compression/decompression component 615, 715, or 825 described with reference to FIGS. 6, 7 and/or 8.

On the uplink (UL), at the UE 1215, a transmit processor 1264 may receive and process data from a data source. The transmit processor 1264 may also generate reference symbols for a reference signal. The symbols from the transmit processor 1264 may be precoded by a transmit MIMO processor 1266 if applicable, further processed by the demodulators 1254ₐ through 1254ₙ (e.g., for SC-FDMA, etc.), and be transmitted to the base station 1205 in accordance with the transmission parameters received from the base station 1205. At the base station 1205, the UL signals from the UE 1215 may be received by the antennas 1234, processed by the demodulators 1232, detected by a MIMO detector 1236 if applicable, and further processed by a receive processor 1238. The receive processor 1238 may provide decoded data to a data output and to the processor 1240 and/or memory 1242. The processor 1240 may in some cases execute stored instructions to instantiate one or more of a base station eDCS component 1210. The base station eDCS component 1210 may be an example of aspects of the base station data compression/decompression component 915, 1015, or 1125 described with reference to FIGS. 9, 10 and/or 11.

The components of the UE 1215 may, individually or collectively, be implemented with one or more ASICs adapted to perform some or all of the applicable functions in hardware. Each of the noted components may be a means for performing one or more functions related to operation of the MIMO communications system 1200. Similarly, the components of the base station 1205 may, individually or collectively, be implemented with one or more ASICs adapted to perform some or all of the applicable functions in hardware. Each of the noted components may be a means for performing one or more functions related to operation of the MIMO communications system 1200.

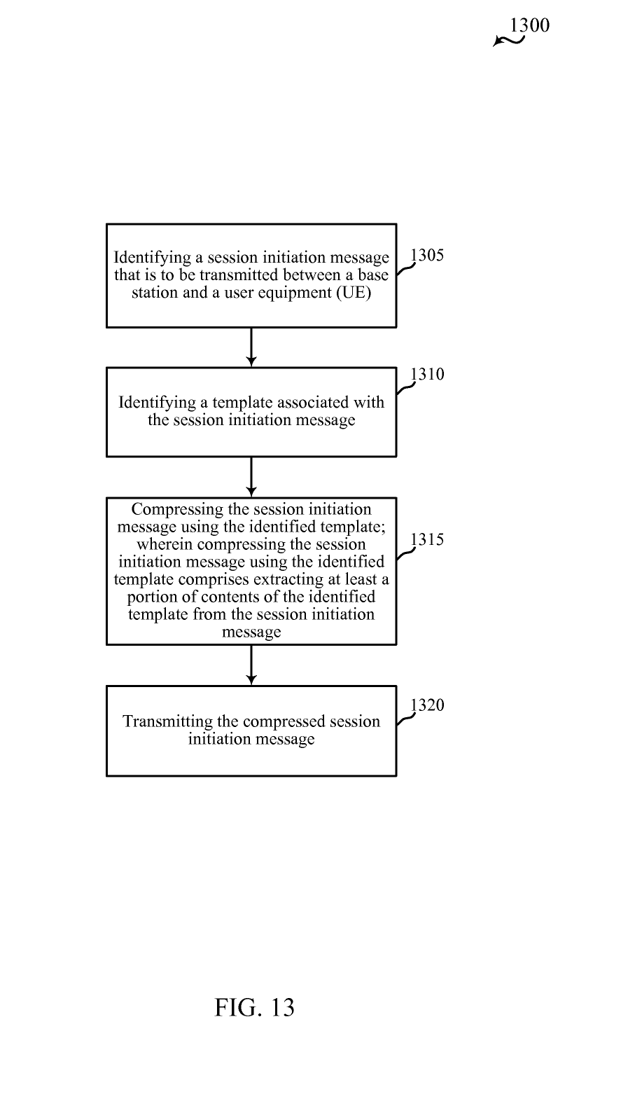

FIG. 13 is a flow chart illustrating an example of a method 1300 for wireless communications, in accordance with various aspects of the present disclosure. For clarity, the method 1300 is described below with reference to aspects of at least one of base station 105, 205, 305, 405, 1105, or 1205 described with reference to FIG. 1, 2, 3, 4, 5, 11, or 12, aspects of at least one of apparatus 905 or apparatus 1005 described with reference to FIG. 9 or 10, aspects of at least one of UE 115, 215, 315, 415, 815, or 1215 described with reference to FIG. 1, 2, 3, 4, 5, 8, or 12, and/or aspects of at least one of device 605 or device 705 described with reference to FIG. 6 or 7. In some examples, a base station or UE may execute one or more sets of codes to control the functional elements of the base station or UE to perform the functions described below. Additionally or alternatively, the base station or UE may perform one or more of the functions described below using special-purpose hardware.

At block 1305, the method 1300 may perform identifying a session initiation message that is to be transmitted between a base station and a user equipment (UE). Such identifying may include, for example identifying a particular type of session initiation message (e.g., a SIP Invite message). The operations at block 1305 may be performed using the UE data compression/decompression component 615, 715 or 825 described with reference to FIG. 6, 7 or 8, session initiation message identification component 725 of FIG. 7, base station data compression/decompression component 915, 1015, or 1125 described with reference to FIG. 9, 10 or 11, message identification component 1025 of FIG. 10, UE eDCS component 1225 of FIG. 12, or base station eDCS component 1210 of FIG. 10.

At block 1310, the method 1300 may perform identifying a template associated with the session initiation message. Such identifying may include, for example identifying a particular template associated with the identified type of session initiation message (e.g., a SIP Invite message template). The operations at block 1310 may be performed using the UE data compression/decompression component 615, 715 or 825 described with reference to FIG. 6, 7 or 8, session initiation message template identification component 730 of FIG. 7, base station data compression/decompression component 915, 1015, or 1125 described with reference to FIG. 9, 10 or 11, template identification component 1030 of FIG. 10, UE eDCS component 1225 of FIG. 12, or base station eDCS component 1210 of FIG. 10.

At block 1315, the method 1300 may perform compressing the session initiation message using the identified template; wherein compressing the session initiation message using the identified template comprises extracting at least a portion of contents of the identified template from the session initiation message. The operations at block 1315 may be performed using the UE data compression/decompression component 615, 715 or 825 described with reference to FIG. 6, 7 or 8, session initiation message compression/decompression component 735 of FIG. 7, base station data compression/decompression component 915, 1015, or 1125 described with reference to FIG. 9, 10 or 11, message compression/decompression component 1035 of FIG. 10, UE eDCS component 1225 of FIG. 12, or base station eDCS component 1210 of FIG. 10.

At block 1320, the method 1300 may perform transmitting the compressed session initiation message. The operations at block 1320 may be performed using the transceiver component 835 and at least one antenna 840 of FIG. 8, using the at least one base station transceiver component 1150 and the at least one base station antenna 1155 of FIG. 11, using the antennas 1234 and modulators/demodulators 1232 of FIG. 12, and/or using the UE antennas 1252 and modulators/demodulators 1254 of FIG. 12.

Thus, the method 1300 may provide for wireless communications. It should be noted that the method 1300 is just one implementation and that the operations of the method 1300 may be rearranged or otherwise modified such that other implementations are possible.

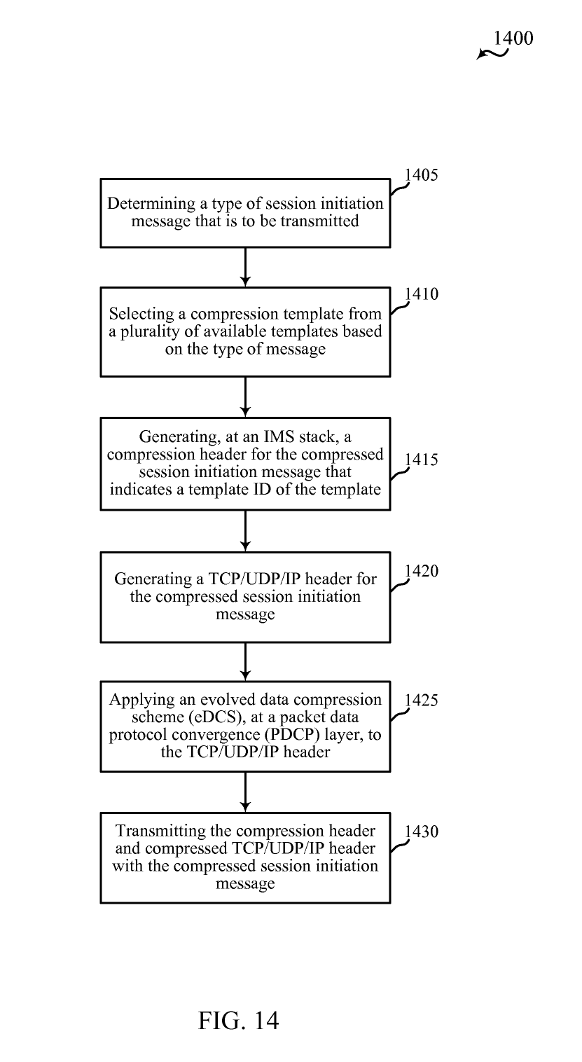

FIG. 14 is a flow chart illustrating an example of a method 1400 for wireless communications, in accordance with various aspects of the present disclosure. For clarity, the method 1400 is described below with reference to aspects of at least one of base station 105, 205, 305, 405, 1105, or 1205 described with reference to FIG. 1, 2, 3, 4, 5, 11, or 12, aspects of at least one of apparatus 905 or apparatus 1005 described with reference to FIG. 9 or 10, aspects of at least one of UE 115, 215, 315, 415, 815, or 1215 described with reference to FIG. 1, 2, 3, 4, 5, 8, or 12, and/or aspects of at least one of device 605 or device 705 described with reference to FIG. 6 or 7. In some examples, a base station or UE may execute one or more sets of codes to control the functional elements of the base station or UE to perform the functions described below. Additionally or alternatively, the base station or UE may perform one or more of the functions described below using special-purpose hardware.

At block 1405, the method 1400 may perform determining a type of session initiation message that is to be transmitted. The operations at block 1405 may be performed using the UE data compression/decompression component 615, 715 or 825 described with reference to FIG. 6, 7 or 8, session initiation message identification component 725 of FIG. 7, base station data compression/decompression component 915, 1015, or 1125 described with reference to FIG. 9, 10 or 11, message identification component 1025 of FIG. 10, UE eDCS component 1225 of FIG. 12, or base station eDCS component 1210 of FIG. 10.

At block 1410, the method 1400 may perform selecting a compression template from a plurality of available templates based on the type of message, Such selecting may include, for example identifying a particular template associated with the identified type of session initiation message (e.g., a SIP Invite message template). The operations at block 1410 may be performed using the UE data compression/decompression component 615, 715 or 825 described with reference to FIG. 6, 7 or 8, session initiation message template identification component 730 of FIG. 7, base station data compression/decompression component 915, 1015, or 1125 described with reference to FIG. 9, 10 or 11, template identification component 1030 of FIG. 10, UE eDCS component 1225 of FIG. 12, or base station eDCS component 1210 of FIG. 10.

At block 1415, the method 1400 may perform generating, at the IMS stack, a compression header for the compressed session initiation message that indicates a template ID of the template. The operations at block 1415 may be performed using the UE data compression/decompression component 615, 715 or 825 described with reference to FIG. 6, 7 or 8, session initiation message compression/decompression component 735 of FIG. 7, base station data compression/decompression component 915, 1015, or 1125 described with reference to FIG. 9, 10 or 11, message compression/decompression component 1035 of FIG. 10, UE eDCS component 1225 of FIG. 12, or base station eDCS component 1210 of FIG. 10.

At block 1420, the method 1400 may perform generating a TCP/UDP/IP header for the compressed session initiation message. The operations at block 1420 may be performed using the UE data compression/decompression component 615, 715 or 825 described with reference to FIG. 6, 7 or 8, session initiation message compression/decompression component 735 of FIG. 7, base station data compression/decompression component 915, 1015, or 1125 described with reference to FIG. 9, 10 or 11, message compression/decompression component 1035 of FIG. 10, UE eDCS component 1225 of FIG. 12, or base station eDCS component 1210 of FIG. 10.

At block 1425, the method 1400 may perform applying an evolved data compression scheme (eDCS), at a packet data convergence protocol (PDCP) layer, to the TCP/UDP/IP header. The operations at block 1425 may be performed using the UE data compression/decompression component 615, 715 or 825 described with reference to FIG. 6, 7 or 8, session initiation message compression/decompression component 735 of FIG. 7, base station data compression/decompression component 915, 1015, or 1125 described with reference to FIG. 9, 10 or 11, message compression/decompression component 1035 of FIG. 10, UE eDCS component 1225 of FIG. 12, or base station eDCS component 1210 of FIG. 10.

At block 1430, the method 1400 may perform transmitting the compression header and compressed TCP/UDP/IP header with the compressed session initiation message. The operations at block 1430 may be performed using the transceiver component 835 and at least one antenna 840 of FIG. 8, using the at least one base station transceiver component 1150 and the at least one base station antenna 1155 of FIG. 11, using the antennas 1234 and modulators/demodulators 1232 of FIG. 12, and/or using the UE antennas 1252 and modulators/demodulators 1254 of FIG. 12.

Thus, the method 1400 may provide for wireless communications. It should be noted that the method 1400 is just one implementation and that the operations of the method 1400 may be rearranged or otherwise modified such that other implementations are possible.

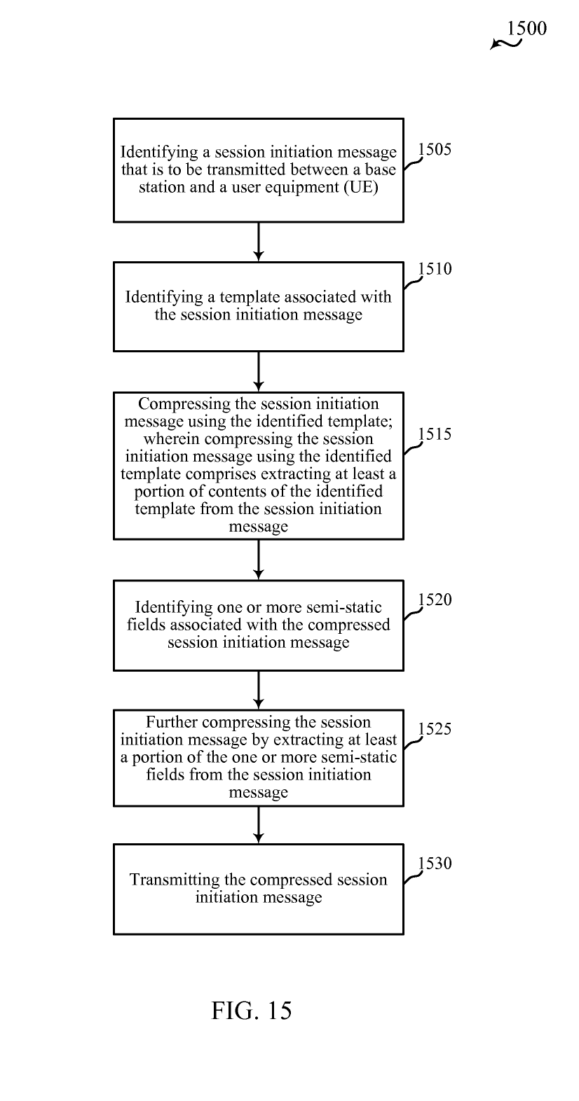

FIG. 15 is a flow chart illustrating an example of a method 1500 for wireless communications, in accordance with various aspects of the present disclosure. For clarity, the method 1500 is described below with reference to aspects of at least one of base station 105, 205, 305, 405, 1105, or 1205 described with reference to FIG. 1, 2, 3, 4, 5, 11, or 12, aspects of at least one of apparatus 905 or apparatus 1005 described with reference to FIG. 9 or 10, aspects of at least one of UE 115, 215, 315, 415, 815, or 1215 described with reference to FIG. 1, 2, 3, 4, 5, 8, or 12, and/or aspects of at least one of device 605 or device 705 described with reference to FIG. 6 or 7. In some examples, a base station or UE may execute one or more sets of codes to control the functional elements of the base station or UE to perform the functions described below. Additionally or alternatively, the base station or UE may perform one or more of the functions described below using special-purpose hardware.

At block 1505, the method 1500 may perform identifying a session initiation message that is to be transmitted between a base station and a user equipment (UE). Such identifying may include, for example identifying a particular type of session initiation message (e.g., a SIP Invite message). The operations at block 1505 may be performed using the UE data compression/decompression component 615, 715 or 825 described with reference to FIG. 6, 7 or 8, session initiation message identification component 725 of FIG. 7, base station data compression/decompression component 915, 1015, or 1125 described with reference to FIG. 9, 10 or 11, message identification component 1025 of FIG. 10, UE eDCS component 1225 of FIG. 12, or base station eDCS component 1210 of FIG. 10.

At block 1510, the method 1500 may perform identifying a template associated with the session initiation message. Such identifying may include, for example identifying a particular template associated with the identified type of session initiation message (e.g., a SIP Invite message template). The operations at block 1510 may be performed using the UE data compression/decompression component 615, 715 or 825 described with reference to FIG. 6, 7 or 8, session initiation message template identification component 730 of FIG. 7, base station data compression/decompression component 915, 1015, or 1125 described with reference to FIG. 9, 10 or 11, template identification component 1030 of FIG. 10, UE eDCS component 1225 of FIG. 12, or base station eDCS component 1210 of FIG. 10.

At block 1515, the method 1500 may perform compressing the session initiation message using the identified template; wherein compressing the session initiation message using the identified template comprises extracting at least a portion of contents of the identified template from the session initiation message. The operations at block 1515 may be performed using the UE data compression/decompression component 615, 715 or 825 described with reference to FIG. 6, 7 or 8, session initiation message compression/decompression component 735 of FIG. 7, base station data compression/decompression component 915, 1015, or 1125 described with reference to FIG. 9, 10 or 11, message compression/decompression component 1035 of FIG. 10, UE eDCS component 1225 of FIG. 12, or base station eDCS component 1210 of FIG. 10.

At block 1520, the method 1500 may perform identifying one or more semi-static fields associated with the compressed session initiation message. The operations at block 1520 may be performed using the UE data compression/decompression component 615, 715 or 825 described with reference to FIG. 6, 7 or 8, session initiation message compression/decompression component 735 of FIG. 7, base station data compression/decompression component 915, 1015, or 1125 described with reference to FIG. 9, 10 or 11, message compression/decompression component 1035 of FIG. 10, UE eDCS component 1225 of FIG. 12, or base station eDCS component 1210 of FIG. 10.

At block 1525, the method 1500 may perform further compressing the session initiation message by extracting at least a portion of the one or more semi-static fields from the session initiation message. The operations at block 1525 may be performed using the UE data compression/decompression component 615, 715 or 825 described with reference to FIG. 6, 7 or 8, session initiation message compression/decompression component 735 of FIG. 7, base station data compression/decompression component 915, 1015, or 1125 described with reference to FIG. 9, 10 or 11, message compression/decompression component 1035 of FIG. 10, UE eDCS component 1225 of FIG. 12, or base station eDCS component 1210 of FIG. 10.

At block 1530, the method 1500 may perform transmitting the compressed session initiation message. The operations at block 1530 may be performed using the transceiver component 835 and at least one antenna 840 of FIG. 8, using at least one base station transceiver component 1150 and the at least one base station antenna 1155 of FIG. 11, using the antennas 1234 and modulators/demodulators 1232 of FIG. 12, and/or using the UE antennas 1252 and modulators/demodulators 1254 of FIG. 12.

Thus, the method 1500 may provide for wireless communications. It should be noted that the method 1500 is just one implementation and that the operations of the method 1500 may be rearranged or otherwise modified such that other implementations are possible.

In some examples, aspects from two or more of the methods 1300-1500 may be combined. It should be noted that the methods 1300, 1400, 1500 are just example implementations, and that the operations of the methods 1300-1500 may be rearranged or otherwise modified such that other implementations are possible.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed and/or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, one or more FPGAs, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communications, comprising:
identifying a session initiation message that is to be transmitted between a base station and a user equipment (UE);
identifying a template associated with the session initiation message;
compressing the session initiation message using the identified template;
wherein compressing the session initiation message using the identified template comprises extracting at least a portion of contents of the identified template from the session initiation message; and
transmitting the compressed session initiation message.

2. The method of claim 1, wherein the template comprises one or more parameters repeated across two or more session initiation messages.

3. The method of claim 2, wherein and the one or more parameters comprise a header field name and header field value.

4. The method of claim 1, wherein identifying the template associated with the session initiation message comprises:
determining a type of session initiation message that is to be transmitted; and
selecting the template from a plurality of available compression templates based on the type of session initiation message.

5. The method of claim 4, wherein the plurality of available compression templates are statically configured.

6. The method of claim 4, wherein the plurality of available compression templates are semi-statically provided by a Proxy-Call Session Control Function (P-CSCF).

7. The method of claim 6, wherein the P-CSCF determines the plurality of available compression templates based on receiving one or more of a particular message type, and determining contents of the particular message type based on the received one or more of the particular message type.

8. The method of claim 1, wherein the session initiation message comprises a plurality of information fields and a payload, and wherein identifying the template associated with the session initiation message comprises identifying the template based on one or more of the plurality of information fields or the payload.

9. The method of claim 1, wherein the compressed session initiation message comprises a template ID that indicates the identified template and one or more values associated with the session initiation message.

10. The method of claim 1, wherein the compressing is performed at an IP multimedia subsystem (IMS) stack.

11. The method of claim 10, wherein the compressing of the session initiation message is enabled during an IMS registration procedure.

12. The method of claim 1, wherein the compressing is performed at a packet data convergence protocol (PDCP) layer.

13. The method of claim 12, wherein the compressing of the session initiation message is enabled using radio resource control (RRC) signaling.

14. The method of claim 12, wherein the compressing is performed using an evolved data compression scheme (eDCS) at the PDCP layer.

15. The method of claim 14, wherein the template is stored in a static eDCS buffer.

16. The method of claim 1, further comprising:
receiving signaling indicating that compressed session initiation messages are to be transmitted; and
transmitting an acknowledgment that the compressed session initiation messages are to be transmitted.

17. The method of claim 16, wherein the signaling comprises session initiation signaling that is received at a Proxy-Call Session Control Function (P-CSCF), and wherein the P-CSCF transmits the acknowledgment.

18. The method of claim 16, wherein the signaling comprises RRC signaling and the acknowledgment is transmitted using the RRC signaling.

19. The method of claim 16, wherein the compressing is performed using an evolved data compression scheme (eDCS) at a PDCP layer, and wherein the signaling comprises RRC signaling indicating that a static eDCS buffer includes the template.

20. The method of claim 1, wherein the compressing the session initiation message is performed at an IP multimedia subsystem (IMS) stack, and wherein the method further comprises:
generating, at the IMS stack, a compression header for the compressed session initiation message that indicates a template ID of the template;
generating a TCP/UDP/IP header for the compressed session initiation message;
applying an evolved data compression scheme (eDCS), at a packet data convergence protocol (PDCP) layer, to the TCP/UDP/IP header; and
transmitting the compression header and the compressed TCP/UDP/IP header with the compressed session initiation message.

21. The method of claim 1, wherein the compressing is performed at a PDCP layer, and wherein the method further comprises:
generating a TCP/UDP/IP header for the compressed session initiation message;
applying an evolved data compression scheme (eDCS) to the TCP/UDP/IP header;
providing an indication where the compressed session initiation message starts and a template ID of the template; and
transmitting the indication and the compressed TCP/UDP/IP header with the compressed session initiation message.

22. The method of claim 21, wherein the template is contained in a static buffer of the eDCS.

23. The method of claim 1, wherein the transmitting comprises:
identifying one or more semi-static fields associated with the compressed session initiation message;
further compressing the session initiation message by extracting at least a portion of the one or more semi-static fields from the session initiation message; and
transmitting the further compressed session initiation message.

24. The method of claim 23, wherein the compressing is performed at a packet data convergence protocol (PDCP) layer using an evolved data compression scheme (eDCS) at the PDCP layer, and wherein the template associated with the session initiation message is updated with the one or more semi-static fields.

25. The method of claim 23, wherein the one or more semi-static fields include one or more of a session initiation uniform resource indicator (URI), an IP address associated with the UE or the base station, or an identification associated with the UE or the base station.

26. The method of claim 23, wherein the compressing the session initiation message using the identified template is performed at an IP multimedia subsystem (IMS) stack, and wherein the further compressing the session initiation message by extracting at least a portion of the one or more semi-static fields from the session initiation message is performed at a packet data convergence protocol (PDCP) layer.

27. The method of claim 1, wherein the session initiation message comprises a session initiation protocol (SIP) message.

28. An apparatus for wireless communications, comprising:
means for identifying a session initiation message that is to be transmitted between a base station and a user equipment (UE);
means for identifying a template associated with the session initiation message;
means for compressing the session initiation message using the identified template; wherein compressing the session initiation message using the identified template comprises extracting at least a portion of contents of the identified template from the session initiation message; and
means for transmitting the compressed session initiation message.

29. An apparatus for wireless communications, comprising:
a processor;
memory in electronic communication with the processor; and
instructions stored in the memory, the instructions being executable by the processor to:
identify a session initiation message that is to be transmitted between a base station and a user equipment (UE);
identify a template associated with the session initiation message;
compress the session initiation message using the identified template;
wherein compressing the session initiation message using the identified template comprises extracting at least a portion of contents of the identified template from the session initiation message; and
transmit the compressed session initiation message.

30. A non-transitory computer-readable medium storing computer-executable code for wireless communications, the code executable by a processor to:
identify a session initiation message that is to be transmitted between a base station and a user equipment (UE);
identify a template associated with the session initiation message;
compress the session initiation message using the identified template; wherein compressing the session initiation message using the identified template comprises extracting at least a portion of contents of the identified template from the session initiation message; and
transmit the compressed session initiation message.
